(19) United States
(12) Patent Application Publication
(10) Pub. No.: US 2018/0216673 A1
(43) Pub. Date: Aug. 2, 2018

(54) FRICTION PART

(71) Applicant: Schaeffler Technologies AG & Co. KG, Herzogenaurach (DE)

(72) Inventor: Andreas Götz, Rastatt (DE)

(73) Assignee: Schaeffler Technologies AG & Co. KG, Herzogenaurach (DE)

(21) Appl. No.: 15/747,837

(22) PCT Filed: Jul. 1, 2016
(86) PCT No.: PCT/DE2016/200301

§ 371 Date: Jan. 26, 2018

(30) Foreign Application Priority Data
Jul. 30, 2015 (DE) 10 2015 214 469.0

(51) Int. Cl. F16D 13/64; F16D 13/72; F16D 69/00

(52) U.S. Cl. CPC F16D 13/648; F16D 13/64; F16D 69/04; F16D 69/00; F16D 2200/0021; F16D 13/72

(57) ABSTRACT

An improved friction part for a frictionally operating device includes friction lining pieces, which are spaced apart from each other by grooves in order to create a friction surface in the form of a circular-ring-shaped disk, especially in respect of suitability for production and/or functionality. In an example embodiment, the friction part has friction lining pieces, which are spaced apart from each other by grooves in order to create a friction surface in the form of a circular-ring-shaped disk, if some or all of the friction lining pieces are in the shape of triangles. The triangular friction lining pieces may be arranged in a plurality of circumferential rows. The grooves between the friction lining pieces may extend as far as a carrier element. Virtually waste-free usage of the linings is thereby possible. A carrier plate can be used as a carrier element, for example.

### CROSS-REFERENCE TO RELATED APPLICATIONS

This application is the United States National Phase of PCT Appln. No. PCT/DE2016/200301 filed Jul. 1, 2016, which claims priority to German Application No. DE102015214469.0 filed Jul. 30, 2015, the entire disclosures of which are incorporated by reference herein.

### TECHNICAL FIELD

The disclosure relates to a friction part for a frictionally operating device, having friction lining pieces, which are spaced apart from each other by grooves in order to create a friction surface in the form of a circular-ring-shaped disk.

### BACKGROUND

German Laid-Open Application DE 10 2012 014 811 A1 discloses a friction part for a frictionally operating device having a ring-shaped friction surface, which has an inner edge and an outer edge, wherein an inner encircling groove, an outer encircling groove and at least one interposed encircling groove arranged between the inner and outer encircling grooves in the radial direction are provided in the friction surface, said grooves each extending in a zigzag or undulating manner between inner and outer inflection points, and a flow connection is provided between the inner edge and the inner encircling groove, between the mutually adjacent encircling grooves and between the outer encircling groove and the outer edge, wherein the friction part has a friction lining carrier, wherein the friction surface is formed by a friction lining, preferably a paper friction lining, applied to the friction lining carrier and comprising a plurality of mutually spaced friction lining segments, between which the encircling grooves and the inner and/or outer edge grooves, optionally also the intermediate grooves, are formed.

A similar friction part is known from German Laid-Open Application DE 10 2012 014 804 A1, wherein connecting grooves extend along a radial and/or the connecting grooves are of rectilinear design. German Patent DE 101 57 483 C2 discloses a molding consisting of fiber-reinforced ceramic composite materials, comprising a core zone and at least one covering layer, which has a higher thermal expansion coefficient than the core zone, wherein the covering layer is a covering layer rich in silicon carbide containing at least thirty percent of silicon carbide by mass and comprising segments which are separated from each other by regions free of covering layer material in the form of joints or by webs composed of a material other than the material of the covering layer.

German Laid-Open Application DE 10 2006 009 565 A1 discloses a brake disk having at least one ring-shaped friction surface, preferably provided on both outer sides, against which a brake lining can be pressed for the purpose of braking, wherein the friction surface comprises a multiplicity of component segments separated materially from each other, at least partially, by expansion joints, wherein the depth of the expansion joints is greater than the permissible wear of the friction surface.

German Laid-Open Application DE 2 353 133 discloses a friction disk, in particular for the use of clutches and disk brakes, wherein the disk is formed by five layers, wherein the first layer is composed of friction material, the second layer is composed of a material with a low modulus of elasticity for pressure, the third layer is composed of a high-strength core, the fourth layer is composed of a material with a low modulus of elasticity for pressure, and the fifth layer is composed of friction material, wherein the friction material of the first and fifth layers is composed of a large number of individual particles.

German Patent DE 103 42 271 B4 discloses a friction-lined plate for a wet frictional selector element, having at least one friction surface in the form of a ring-shaped disk used for frictional engagement, which has grooves starting from the inside diameter of the friction surface, through which a coolant flows, wherein the grooves form two superimposed sets of grooves, the friction-lined plate is rotatable in the installed state without a preferential direction of rotation, and the friction surface does not have groove edges aligned perpendicularly to the direction of rotation.

### BRIEF SUMMARY

The present disclosure describes an improved friction part for a frictionally operating device, having friction lining pieces, which are spaced apart from each other by grooves in order to create a friction surface in the form of a circular-ring-shaped disk, especially in respect of suitability for production and/or functionality.

In an example embodiment, the friction part has friction lining pieces, which are spaced apart from each other by grooves in order to create a friction surface in the form of a circular-ring-shaped disk, if some or all of the friction lining pieces are in the shape of triangles. The triangular friction lining pieces may be arranged in a plurality of circumferential rows. By means of the triangular friction lining pieces, the same groove pattern can be created in a simple manner over the entire extent of the friction surface. By means of a 90-degree rotation of individual triangles, it is possible to deliberately interrupt circumferential grooves in order to ensure that the entire ring surface of the steel plate participates in the frictional contact. The grooves between the friction lining pieces may extend as far as a carrier element. Virtually waste-free usage of the linings is thereby possible. A carrier plate can be used as a carrier element, for example.

In another example embodiment, the friction part has friction lining pieces, which are spaced apart from each other by grooves in order to create a friction surface in the form of a circular-ring-shaped disk, if some or all of the friction lining pieces are in the shape of quadrilaterals. The quadrilateral friction lining pieces may be arranged in a plurality of circumferential rows. By means of the quadrilateral friction lining pieces, the same groove pattern can be created in a simple manner over the entire extent of the friction surface. The grooves between the friction lining pieces maymay extend as far as a carrier element. In this case, the grooves can be embodied with a constant width or a varying width. A carrier plate can be used as the carrier element, for example. The quadrilaterals are rectangles and/or rectangle segments, for example. The quadrilaterals can also be rhomboids or rhomboid segments. Moreover, the quadrilaterals can be trapezoids or trapezoid segments. Furthermore, the quadrilaterals can be parallelograms or parallelogram segments.

In another example embodiment, the friction part has friction lining pieces, which are spaced apart from each other by grooves in order to create a friction surface in the form of a circular-ring-shaped disk, if some or all of the friction lining pieces are in the shape of hexagons. The hexagonal friction lining pieces may be arranged in a plurality of circumferential rows. By means of the hexagonal friction lining pieces, the same groove pattern can be created in a simple manner over the entire extent of the friction surface. Since all the angles of a hexagon are obtuse, the risk that the corners will be detached under load is particularly low. The grooves between the friction lining pieces may extend as far as a carrier element. A carrier plate can be used as the carrier element, for example.

In another example embodiment, the friction part has friction lining pieces, which are spaced apart from each other by grooves in order to create a friction surface in the form of a circular-ring-shaped disk, if some or all of the friction lining pieces are in the shape of crosses. The numerous changes in direction of the oil flowing through the grooves which are caused thereby ensure a longer dwell time of the oil in the friction surface, especially at relatively high speeds. The crosses may be arranged in a plurality of circumferential rows. By means of the crosses, the same groove pattern can be created in a simple manner over the entire extent of the friction surface. The grooves between the friction lining pieces may extend as far as a carrier element. A carrier plate can be used as the carrier element, for example.

In another example embodiment, the friction part has friction lining pieces, which are spaced apart from each other by grooves in order to create a friction surface in the form of a circular-ring-shaped disk, if some or all of the friction lining pieces are in the shape of circles and/or circular segments. The circles and/or circular segments may be arranged in a plurality of circumferential rows. By means of the circles and/or circular segments, the same groove pattern can be created in a simple manner over the entire extent of the friction surface. The grooves between the friction lining pieces may extend as far as a carrier element. A carrier plate can be used as the carrier element, for example. The circles are complete circles, for example. However, the friction lining pieces can also be in the shape of partial circles or circular segments.

In another example embodiment, the friction part has friction lining pieces, which are spaced apart from each other by grooves in order to create a friction surface in the form of a circular-ring-shaped disk, if some or all of the friction lining pieces have at least one undulating boundary line. The undulations serve, inter alia, as an additional flow resistance. The friction lining pieces with the undulating boundary line may be arranged in a plurality of circumferential rows. By means of the undulating boundary line, the same groove pattern can be created in a simple manner over the entire extent of the friction surface. The grooves between the friction lining pieces may extend as far as a carrier element. A carrier plate can be used as the carrier element, for example.

In another example embodiment, the friction part has friction lining pieces, which are spaced apart from each other by grooves in order to create a friction surface in the form of a circular-ring-shaped disk, if some or all of the friction lining pieces have vertical groove walls delimiting the grooves. The grooves between the friction lining pieces may extend as far as a carrier element. A carrier plate can be used as the carrier element, for example. The friction lining pieces with the vertical groove walls are simple and inexpensive to produce, e.g. by punching.

In another example embodiment, the friction part has friction lining pieces, which are spaced apart from each other by grooves in order to create a friction surface in the form of a circular-ring-shaped disk, if some or all of the friction lining pieces have oblique groove walls delimiting the grooves. The grooves between the friction lining pieces may extend as far as a carrier element. A carrier plate can be used as the carrier element, for example. The oblique groove walls can extend obliquely inward from the friction surface, wherein the term “inward” refers to the respective friction lining piece. The obliquely inward-extending groove walls result in a lower pressure per unit area for a comparable groove cross section. This results in lower specific loading, in particular more positive μ gradients. Moreover, an unwanted upward-float effect can be reduced by means of the obliquely inward-extending groove walls. According to another illustrative embodiment, however, it is also possible for the groove walls to extend obliquely outward from the friction surface. As with the term “inward” above, the term “outward” refers to the respective friction lining piece. By means of the obliquely outward-extending groove walls, large-area adhesive bonding can be ensured, even in the case of relatively small friction lining pieces. This reduces the risk in respect of detachment of a friction lining piece from the carrier element.

In another example embodiment, the friction part has friction lining pieces, which are spaced apart from each other by grooves in order to create a friction surface in the form of a circular-ring-shaped disk, if some or all of the friction lining pieces have a level surface. The grooves between the friction lining pieces may extend as far as a carrier element. A carrier plate can be used as the carrier element, for example. In particular, the friction lining surface with a level surface can be formed without imprinting. This means that the grooves are formed solely by the shape and arrangement of the friction lining pieces.

In another example embodiment, the friction part has friction lining pieces, which are spaced apart from each other by grooves in order to create a friction surface in the form of a circular-ring-shaped disk, if some or all of the friction lining pieces have a surface with raised portions and/or depressions, which serve to form grooves in the surface. The grooves in the friction lining pieces may do not extend as far as a carrier element. A carrier plate can be used as the carrier element, for example. The raised portions and/or depressions or grooves can be introduced into the surface of the friction lining pieces before or after the friction lining pieces are adhesively bonded onto the carrier element. The raised portions and/or depressions or grooves can be produced in the friction lining pieces by imprinting, for example. The phrase “friction lining pieces with an imprint” is then also used. The grooves produced or formed by the raised portions and/or depressions can be provided between the friction lining pieces as an alternative or in addition to the grooves described above.

An illustrative embodiment of the friction part is characterized in that the friction surface has friction lining pieces with the same shape. This considerably simplifies the production of the friction parts.

Another illustrative embodiment of the friction part is characterized in that the friction surface has two different types of friction lining piece. It is thereby possible to produce a larger variety of grooves in a simple manner.

Another illustrative embodiment of the friction part is characterized in that some or all of the friction lining pieces or all the friction lining pieces are aligned radially. In this case, the friction lining pieces may be arranged in a uniformly distributed manner in the circumferential direction.

Another illustrative embodiment of the friction part is characterized in that some or all of the friction lining pieces are arranged parallel to each other. This has the advantage that different groove paths can be formed using the same friction lining pieces.

Another illustrative embodiment of the friction part is characterized in that some or all of the friction lining pieces are aligned differently in segments. This has the advantage that different groove paths can be formed using the same friction lining pieces. In particular, it is thereby possible to have imprinted grooves extending primarily in the circumferential direction. This reduces the risk of upward-float effects at relatively high differential speeds.

Another illustrative embodiment of the friction part is characterized in that the friction lining pieces are arranged differently in segments. This further increases the variety of grooves which can be produced.

The disclosure also optionally relates to a method for producing a friction part described above. The friction part may comprises a carrier element, e.g. a carrier plate, on which the friction lining pieces are secured, e.g. by adhesive bonding.

The disclosure furthermore relates to a clutch disk having at least one friction part described above. The friction part may be provided with the friction lining pieces on both sides.

### BRIEF DESCRIPTION OF THE DRAWINGS

Further advantages, features and details of the disclosure will become apparent from the following description, in which various illustrative embodiments are described in detail with reference to the drawing, in which:

FIG. 1 shows a view of a quarter of a friction part having triangular friction lining pieces according to a first illustrative embodiment;

FIG. 2 shows a view of a quarter of a friction part having triangular friction lining pieces according to a second illustrative embodiment;

FIG. 3 shows a view of a quarter of a friction part having rectangular friction lining pieces, which are aligned radially with a radially constant or increasing groove width;

FIG. 4 shows a view of a quarter of a friction part having trapezoidal friction lining pieces, which are arranged radially with a radially decreasing groove width;

FIG. 5 shows a view of a quarter of a friction part having rectangular friction lining pieces, which are arranged horizontally and parallel to each other, wherein the friction lining pieces are furthermore provided with an imprint;

FIG. 6 shows a view of a quarter of a friction part having rectangular friction lining pieces, which are aligned differently and provided with an imprint, which may extend primarily in the circumferential direction;

FIG. 7 shows a view of a quarter of a friction part having substantially trapezoidal friction lining pieces, which are provided with an imprint;

FIG. 8 shows an arrangement of substantially trapezoidal friction lining pieces during the virtually waste-free production thereof;

FIG. 9 shows a view of a quarter of a friction part having substantially trapezoidal friction lining pieces, which are provided with an imprint;

FIG. 10 shows an arrangement of the substantially trapezoidal friction lining pieces with the imprint during the virtually waste-free production thereof;

FIG. 11 shows a view of a quarter of a friction part having rhomboidal friction lining pieces, which are combined with substantially triangular friction lining pieces;

FIG. 12 shows a view of a quarter of a friction part having rhomboidal friction lining pieces, which are arranged in two circumferential rows and are combined with substantially triangular friction lining pieces;

FIG. 13 shows a view of a quarter of a friction part having friction lining pieces which have the shape of parallelograms or parallelogram segments;

FIG. 14 shows an arrangement of the parallelogram-type friction lining pieces during the virtually waste-free production thereof;

FIG. 15 shows a view of a quarter of a friction part having hexagonal friction lining pieces, which are arranged in rows parallel to each other;

FIG. 16 shows a similar friction part to that in FIG. 15, which has more and smaller hexagonal friction lining pieces than in FIG. 15;

FIG. 17 shows a similar illustration to that in FIG. 16, wherein the hexagonal friction parts are arranged in units which are repeated in the circumferential direction;

FIG. 18 shows two repeated units of hexagonal friction lining pieces during the virtually waste-free production thereof;

FIG. 19 shows a view of a quarter of a friction part having cross-shaped friction lining pieces, which are arranged in rows parallel to each other;

FIG. 20 shows a view of a quarter of a friction part having cross-shaped friction lining pieces, which are arranged in units which are repeated in the circumferential direction;

FIG. 21 shows a view of a quarter of a friction part having circular friction lining pieces, which are arranged in rows that extend parallel to one another;

FIG. 22 shows a view of a quarter of a friction part having circular friction lining pieces, which are arranged in units which are repeated in the circumferential direction;

FIG. 23 shows a friction part having similar friction lining pieces to those in FIG. 22, but which have a different unit repeated in the circumferential direction;

FIG. 24 shows a view of a quarter of a friction part having circular friction lining pieces, which are arranged radially between two friction lining pieces, each embodied in partially complementary fashion;

FIG. 25 shows a similar illustrative embodiment to that in FIG. 24 in accordance with another illustrative embodiment;

FIG. 26 shows a similar friction part to that in FIG. 25 having circular friction lining pieces, which are arranged in two circumferential rows;

FIG. 27 shows a similar friction part to that in FIG. 26 with a different repeated unit;

FIG. 28 shows a similar friction part to that in FIG. 27 with a different repeated unit;

FIG. 29 shows a view of a quarter of a friction part having friction lining pieces which have undulating boundary lines;

FIG. 30 shows a section through a friction part having friction lining pieces which have oblique groove walls extending obliquely outward from a friction surface;

FIG. 31 shows a similar illustration to that in FIG. 30 having groove walls which extend obliquely inward from the friction surface;

FIG. 32 shows a similar illustration to that in FIG. 6 with friction lining pieces which are provided with a different imprint;

FIG. 33 shows a similar illustration to that in FIG. 32 with friction lining pieces which are provided with an imprint in accordance with another illustrative embodiment, and

FIG. 34 shows a similar illustration to that in FIG. 1, which no longer has any grooves in a purely circumferential direction.

### DETAILED DESCRIPTION

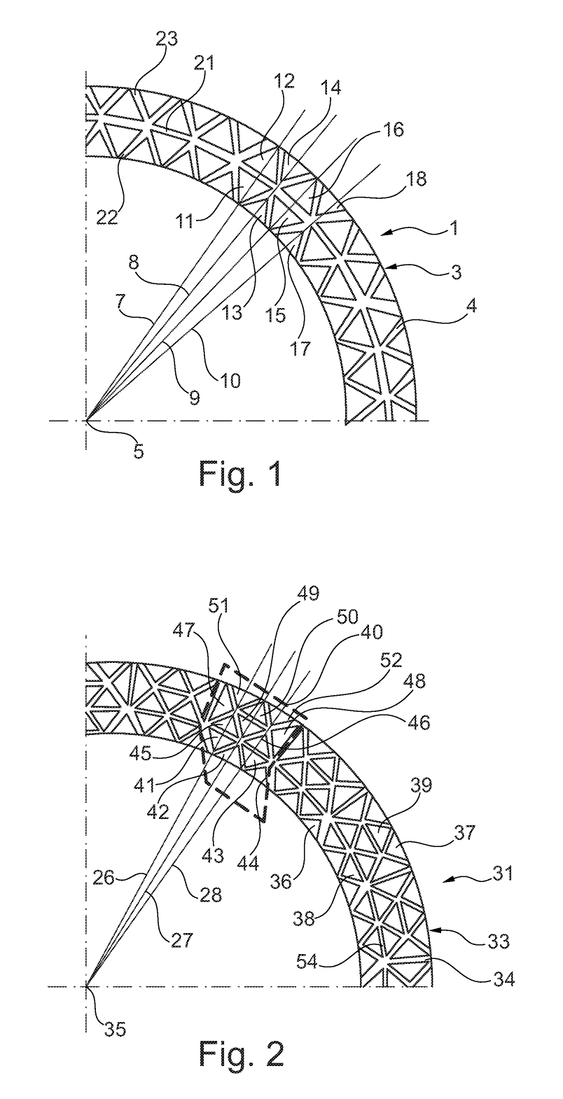

The illustrative embodiments shown in FIGS. 1 to 31 relate to multiplate clutches with friction plates, which are also referred to as friction parts. The friction plates may be embodied as inner plates and as outer plates and arranged in a multiplate pack. The inner plates and outer plates are substantially in the shape of circular-ring-shaped disks with rectangular ring cross sections.

The inner plates each comprise a lining carrier, which is also referred to as a carrier element and on which two friction linings may be mounted in each case. The lining carriers are formed from a steel material, for example. Depending on the embodiment, the lining carriers or carrier elements are also referred to as carrier plates.

The friction linings may be formed from a suitable lining material. In a contact region, the inner plates can be brought into contact by means of the friction linings thereof with the outer plates. For this purpose, an inner plate with the lining carrier and friction linings is arranged axially between two outer plates in each case.

The term “axially” refers to an axis of rotation of the multiplate pack. “Axially” means in the direction of or parallel to the axis of rotation. Similarly, “radially” means transversely to the axis of rotation. The lining carriers each have a coupling region radially on the inside or radially on the outside.

The coupling regions of the lining carriers are embodied as internal toothing or external toothing, for example. The sets of toothing are used to engage the lining carriers in a corresponding plate carrier.

In each of FIGS. 1 to 29, the friction plates, also referred to as friction parts, are shown in a quarter section. A multiplicity of friction lining pieces is secured on the carrier elements of the friction parts to form a friction surface in the form of a circular-ring-shaped disk. The friction lining pieces have different shapes and are spaced apart from each other in such a way that grooves are formed between the friction lining pieces, said grooves extending as far as the carrier element.

FIGS. 1 and 2 as well as 34 relate to a friction part for a frictionally operating device, having friction lining pieces, which are spaced apart from each other by grooves in order to create a friction surface in the form of a circular-ring-shaped disk, wherein some or all of the friction lining pieces are in the shape of triangles. The triangles are secured on a carrier element and spaced apart from each other in such a way that grooves are formed between the friction lining pieces.

An illustrative embodiment of the friction part is characterized in that the friction part has the same groove pattern over its entire extent. Uniform flow through the grooves in the region of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment of the friction part is characterized in that triangular lining pieces are arranged alternately with the vertex thereof pointing inward and the vertex thereof pointing outward in at least one circumferential row. This arrangement results in obliquely extending grooves which extend in different directions.

Another illustrative embodiment of the friction part is characterized in that, in at least one circumferential row, triangular friction lining pieces are arranged in such a way that radially extending grooves are formed in this circumferential row. This arrangement has proven advantageous especially in combination with the obliquely extending grooves.

Another illustrative embodiment of the friction part is characterized in that, in at least one circumferential row, triangular friction lining pieces are arranged in such a way that obliquely extending grooves are formed in this circumferential row. This further improves the functionality of the friction part.

Another illustrative embodiment of the friction part is characterized in that the friction part has two circumferential rows, in which triangular friction lining pieces are arranged alternately with the vertex thereof pointing inward and with the vertex thereof pointing outward, wherein the vertices of radially inwardly arranged friction lining pieces of a radially inner circumferential row and the vertices of radially outwardly arranged friction lining pieces of a radially outer circumferential row point toward each other. A groove extending in the circumferential direction, which is also referred to as a circumferential groove, is advantageously obtained between the two circumferential rows. Oblique grooves extend radially inward and radially outward from the circumferential groove.

Another illustrative embodiment of the friction part is characterized in that the vertices of radially outwardly arranged friction lining pieces of the radially inner circumferential row and the vertices of radially inwardly arranged friction lining pieces of the radially outer circumferential row point away from each other. A unitary groove pattern is thereby obtained in a simple manner.

Another illustrative embodiment of the friction part is characterized in that a number of triangular friction lining pieces is arranged in units that are repeated in the circumferential direction. According to one illustrative embodiment, four triangular friction lining pieces are arranged in a respective repeated unit. According to another illustrative embodiment, more than ten, in particular eleven, triangular friction lining pieces are arranged in the repeated unit.

Another illustrative embodiment of the friction part is characterized in that the triangular friction lining pieces are of substantially the same size. This further simplifies the production of the friction part.

A friction part 1 having a carrier element 3 is shown in a quarter section in FIG. 1. Carrier element 3 is embodied as a circular-ring-shaped disk 4 made from a steel material, for example. Radially on the inside or radially on the outside, circular-ring-shaped disk 4 is provided with inner toothing or outer toothing (not shown), for example, to form a coupling region.

Radial lines 7, 8, 9, 10, which are also referred to as radials for short, start from a circle center 5. Friction lining pieces 11 to 18 are secured on carrier element 3 to form a friction surface in the form of a circular-ring-shaped disk. The friction lining pieces 11 to 18 are spaced apart from each other in such a way that grooves are formed between the friction lining pieces 11 to 18, said grooves extending as far as carrier element 3.

Friction lining pieces 11 and 12 are arranged on radial 7. A vertex of friction lining piece 11 is oriented radially inward. A vertex of friction lining piece 12 is oriented radially outward. Friction lining piece 15 is arranged on radial 9 with the vertex thereof pointing radially inward. Friction lining piece 13 is arranged on radial 8 with the vertex thereof pointing radially outward, between friction lining pieces 11 and 15.

Friction lining piece 14 is likewise arranged on radial 8 with the vertex thereof pointing radially inward. Here, friction lining piece 14 is arranged between friction lining piece 12 and friction lining piece 16 in the circumferential direction. Friction lining piece 16 is arranged on radial 9 with the vertex thereof pointing radially outward.

Friction lining pieces 17 and 18 are arranged on radial 10 with the vertices thereof pointing toward each other. The radially inner friction lining pieces 13 and 17 are bounded radially on the inside by a circular arc. Similarly, the friction lining pieces 14 and 18 arranged radially on the outside are bounded radially on the outside by a circular arc.

In a radially inner circumferential row, the triangular friction lining pieces 11, 13, 15 and 17 are arranged alternately with the vertex thereof pointing inward and the vertex thereof pointing outward. In a radially outer circumferential row, the triangular friction lining pieces 12, 14, 16 and 18 are arranged alternately with the vertex thereof pointing outward and the vertex thereof pointing inward.

The vertices of the radially inwardly arranged friction lining pieces 13, 17 in the radially inner circumferential row point toward the vertices of the radially outwardly arranged friction lining pieces 14, 18 in the radially outer circumferential row.

A continuous circumferential groove 21 is formed between the two circumferential rows containing the triangular friction lining pieces 11 to 18. The circumferential groove 21 intersects oblique grooves 22, 23. This results in an x-shaped groove path which is repeated in the circumferential direction.

A friction part 31 having a carrier element 33 is shown in a quarter section in FIG. 2. Carrier element 33 is embodied as a circular-ring-shaped disk 34 made from a steel material, for example. Radially on the inside or radially on the outside, circular-ring-shaped disk 34 is provided with inner toothing or outer toothing (not shown), for example, to form a coupling region.

Radial lines 26, 27, 28, which are also referred to as radials for short, start from a circle center 35. Friction lining pieces 41 to 48 are secured on carrier element 33 to form a friction surface in the form of a circular-ring-shaped disk. Friction lining pieces 41 to 48 are spaced apart from each other in such a way that grooves are formed between friction lining pieces 41 to 48, said grooves extending as far as carrier element 33.

Friction part 31 comprises an inner circumferential row containing triangular friction lining pieces 36, which are aligned radially. A vertex of friction lining pieces 36 points radially outward. Radially on the outside, friction part 31 comprises a further circumferential row containing triangular friction lining pieces 37. Friction lining pieces 37 are likewise aligned radially.

A vertex of friction lining pieces 37 points radially inward. The radially inner circumferential row furthermore comprises friction lining pieces 38 in the form of triangles, having a vertex which is oriented radially inward. Similarly, the radially outer circumferential row comprises friction lining pieces 39, which are aligned radially and the vertex of which points radially outward.

In the case of the friction part 31 shown in FIG. 2, a total of twelve friction lining pieces 41 to 52 is arranged in a repeated unit 40. In the radially inner circumferential row, friction lining pieces 41 to 44 are arranged alternately with the vertices thereof pointing radially inward and radially outward. Friction lining pieces 45 and 46 are arranged radially on the outside of friction lining pieces 41 and 43 with the vertices thereof pointing radially outward. Friction lining piece 49 is arranged between friction lining pieces 45 and 46 with the vertex thereof pointing radially inward. Friction lining piece 50 is arranged radially on the outside of friction lining piece 49 with the vertex thereof pointing radially outward.

Friction lining pieces 51, 50 and 52 are arranged with the vertices thereof pointing alternately radially inward and radially outward. In the counterclockwise circumferential direction, the repeated unit 40 is bounded by friction lining piece 47, the vertex of which points toward a vertex of friction lining piece 48, which bounds the unit 40 on the other side in the circumferential direction in FIG. 2.

Friction part 31 comprises a circumferential groove 54, which is continuous in the circumferential direction, and a multiplicity of obliquely extending grooves, which intersect each other and circumferential groove 54. Moreover, friction part 31 comprises radially extending grooves radially on the outside.

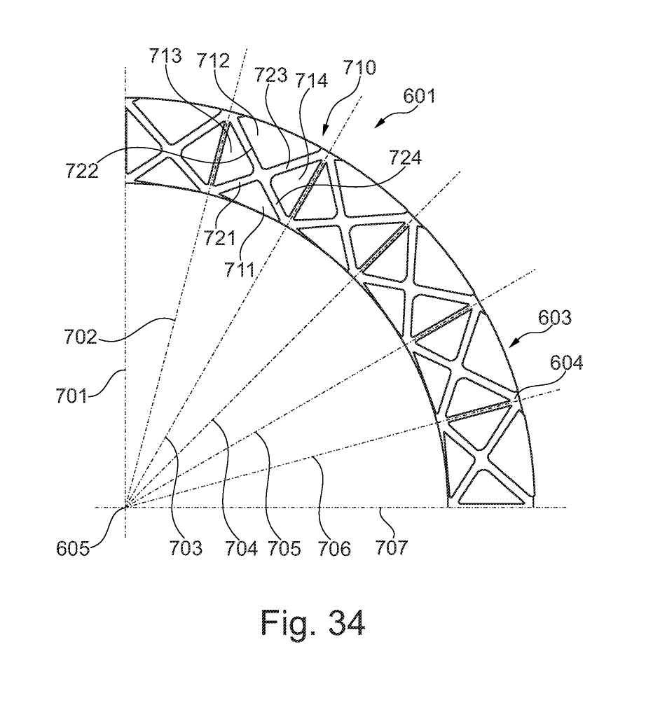

A friction part 601 having a carrier element 603 is shown in a quarter section in FIG. 34. Carrier element 603 is embodied as a circular-ring-shaped disk 604 made from a steel material, for example. Radially on the inside or radially on the outside, circular-ring-shaped disk 604 is provided with inner toothing or outer toothing (not shown), for example, to form a coupling region.

Radial lines 701 to 707, which are also referred to as radials for short, start from a circle center 605. Friction lining pieces 711 to 714 are secured on carrier element 603 to form a friction surface in the form of a circular-ring-shaped disk. Friction lining pieces 711 to 714 are spaced apart from each other in such a way that grooves 721 to 724 are formed between friction lining pieces 711 to 714, said grooves extending as far as carrier element 3.

The triangular friction lining pieces 711 to 714 are arranged in a repeated unit 710. Triangular friction lining piece 711 is arranged radially on the inside in the repeated unit 710 and the vertex thereof points radially outward. Triangular friction lining piece 712 is arranged radially on the outside in the repeated unit 710 and the vertex thereof points radially inward.

The two triangular friction lining pieces 713 and 714 are aligned on radials 702 and 703 in the repeated unit 710, wherein the vertices of triangular friction lining pieces 713 and 714 point toward each other. A respective groove is formed between the repeated units 710 along one of radials 701 to 707. Grooves 721 to 724 have an x-shaped groove pattern in the repeated unit 710.

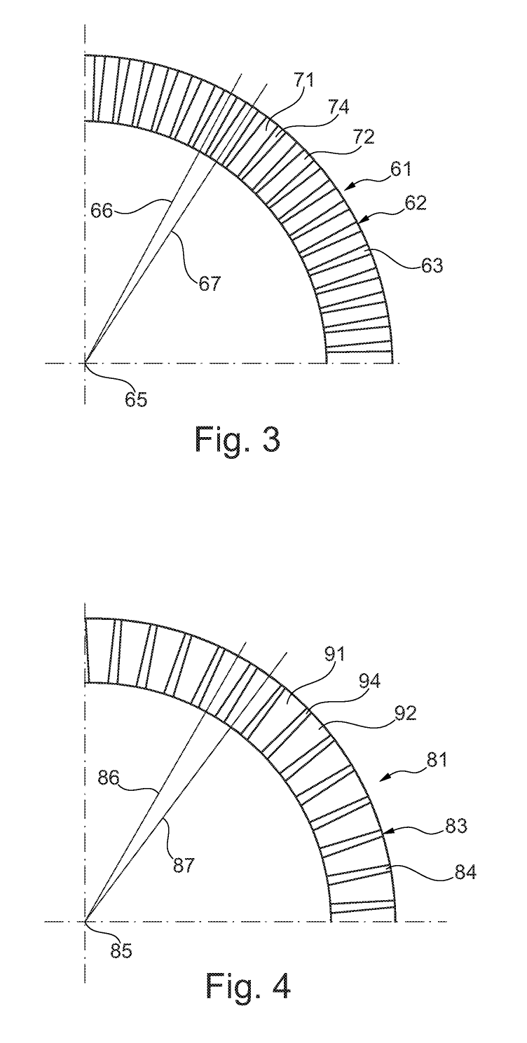

FIGS. 3 to 14 relate to a friction part for a frictionally operating device, having friction lining pieces, which are spaced apart from each other by grooves in order to create a friction surface in the form of a circular-ring-shaped disk, wherein some or all of the friction lining pieces are in the shape of quadrilaterals. The quadrilaterals are rectangles, rhomboids, trapezoids or parallelograms, for example.

An illustrative embodiment of the friction part is characterized in that the friction part has the same groove pattern over its entire extent. Uniform flow through the grooves during the operation of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment is characterized in that some or all of the friction lining pieces are substantially in the shape of rectangles or rectangle segments. “Substantially in the shape of rectangles” means that the rectangles can also have the shape of circular arcs radially on the inside and/or radially on the outside, for example. However, it is also possible for some or all of the friction lining pieces to be in the shape of rectangles or rectangle segments.

Another illustrative embodiment is characterized in that the substantially rectangular friction lining pieces have boundary lines in the form of circular arcs radially on the inside and/or radially on the outside. The circular-arc-shaped boundary lines are used to match the shape of the friction lining pieces to an inner radius or outer radius of the friction surface in the form of a circular-ring-shaped disk.

Another illustrative embodiment is characterized in that the substantially rectangular friction lining pieces are aligned radially in the longitudinal direction thereof. Grooves which widen radially toward the outside between the rectangular friction lining pieces are thereby obtained in a simple manner.

Another illustrative embodiment is characterized in that the substantially rectangular friction lining pieces are arranged parallel to each other in the longitudinal direction thereof over the entire friction surface. The effect is that the grooves between the rectangular friction lining pieces extend parallel to each other over the entire friction surface.

Another illustrative embodiment is characterized in that the substantially rectangular friction lining pieces are arranged parallel to each other in groups in the longitudinal direction thereof but are oriented differently. In this case, the friction lining pieces may be arranged parallel to each other in groups in the manner of segments.

Another illustrative embodiment is characterized in that some or all of the friction lining pieces are substantially in the shape of trapezoids or trapezoid segments. “Substantially in the shape of trapezoids or trapezoid segments” means that the trapezoids or trapezoid segments can have the shape of circular arcs radially on the inside and/or radially on the outside. The trapezoidal shape of the friction lining pieces advantageously provides many different design possibilities for the friction surfaces with the grooves.

Another illustrative embodiment is characterized in that the substantially trapezoidal friction lining pieces have circular-arc-shaped boundary lines radially on the inside and/or radially on the outside. The circular-arc-shaped boundary lines are advantageously matched to an inner circumference or outer circumference of the friction surface in the form of a circular-ring-shaped disk of the friction part.

Another illustrative embodiment is characterized in that the substantially trapezoidal friction lining pieces are aligned radially in the longitudinal direction thereof. This arrangement results in radially extending grooves between the friction lining pieces.

Another illustrative embodiment is characterized in that the trapezoids widen radially outward. This provides many other design possibilities for the groove paths between the friction lining pieces.

Another illustrative embodiment is characterized in that the grooves between the substantially trapezoidal friction lining pieces extend radially. The grooves may be uniformly distributed in the circumferential direction.

Another illustrative embodiment is characterized in that the grooves between the substantially trapezoidal friction lining pieces taper radially outward. It is thereby possible to extend the dwell time of fluid in the grooves in the region of the friction part.

Another illustrative embodiment is characterized in that the trapezoids are isosceles trapezoids. It is thereby possible to achieve uniform mass distribution over the friction surface in a simple manner.

Another illustrative embodiment is characterized in that some or all of the friction lining pieces are in the shape of rhomboids or rhomboid segments. By means of different shapes and/or arrangements of the rhomboidal or rhomboid-segment-shaped friction lining pieces, many different design possibilities are obtained, especially in respect of the groove paths between the friction lining pieces.

Another illustrative embodiment is characterized in that the rhomboidal friction lining pieces are aligned radially in the longitudinal direction thereof. With this arrangement, it is possible to form obliquely extending grooves between the friction lining pieces in a simple manner.

Another illustrative embodiment is characterized in that the rhomboidal friction lining pieces are arranged in a single circumferential row. A uniform groove path is thereby obtained in a simple manner.

Another illustrative embodiment is characterized in that the rhomboidal friction lining pieces are arranged in a plurality of circumferential rows. It is thereby possible in a simple manner to form grooves extending obliquely in different directions between the friction lining pieces.

Another illustrative embodiment is characterized in that the friction part having the rhomboidal friction lining pieces has, radially on the inside, a circumferential row in which substantially triangular or rhomboid-segment-shaped friction lining pieces are arranged with the vertex thereof pointing radially outward. In combination with the rhomboidal friction lining pieces, this results in many different design possibilities.

Another illustrative embodiment is characterized in that the substantially triangular or rhomboid-segment-shaped friction lining pieces have circular-arc-shaped boundary lines radially on the inside. The circular-arc-shaped boundary lines may be matched to an inner circumference of the friction surface in the form of a circular-ring-shaped disk.

Another illustrative embodiment is characterized in that the friction part having the rhomboidal friction lining pieces has, radially on the outside, a circumferential row in which substantially triangular or rhomboid-segment-shaped friction lining pieces are arranged with the vertex thereof pointing radially inward. In combination with the rhomboidal friction lining pieces, this results in many different design possibilities, especially in respect of the groove path.

Another illustrative embodiment is characterized in that the substantially triangular or rhomboid-segment-shaped friction lining pieces have circular-arc-shaped boundary lines radially on the outside. The circular-arc-shaped boundary lines are advantageously matched to an outer circumference of the friction surface in the form of a circular-ring-shaped disk.

Another illustrative embodiment is characterized in that some or all of the friction lining pieces are in the shape of parallelograms. By means of the parallelogram shape, it is possible in a simple manner to combine radially extending grooves in the friction surface in the form of a circular-ring-shaped disk with obliquely extending grooves.

Another illustrative embodiment is characterized in that the parallelogram-shaped friction lining pieces are aligned radially. With the radial alignment, a plurality of parallelogram-shaped friction lining pieces may be arranged on one radial.

Another illustrative embodiment is characterized in that the parallelogram-shaped friction lining pieces are arranged in a single circumferential row. Here, the parallelogram-shaped friction lining pieces in a single circumferential row may face each other alternately with long sides and short sides.

Another illustrative embodiment is characterized in that the parallelogram-shaped friction lining pieces are arranged in a plurality of circumferential rows. It is thereby possible in a simple manner to form a large number of deflection points in the friction surface in the form of a circular-ring-shaped disk.

Another illustrative embodiment is characterized in that the friction part having the parallelogram-shaped friction lining pieces has, radially on the inside, a circumferential row in which are arranged substantially parallelogram-shaped or parallelogram-segment-shaped friction lining pieces which have circular-arc-shaped boundary lines radially on the inside. This simplifies the formation of a friction surface in the form of a circular-ring-shaped disk.

Another illustrative embodiment is characterized in that the friction part having the parallelogram-shaped friction lining pieces has, radially on the outside, a circumferential row in which are arranged substantially parallelogram-shaped or parallelogram-segment-shaped friction lining pieces which have circular-arc-shaped boundary lines radially on the outside. This further simplifies the formation of a friction surface in the form of a circular-ring-shaped disk.

Another illustrative embodiment is characterized in that a number of quadrilateral friction lining pieces is arranged in units which are repeated in the circumferential direction. This further simplifies the production of the friction part.

Another illustrative embodiment is characterized in that the quadrilateral friction lining pieces are of substantially the same size. This further simplifies the production of the friction part.

A friction part 61 having a carrier element 63 is shown in a quarter section in FIG. 3. Carrier element 63 is embodied as a circular-ring-shaped disk 64 made from a steel material, for example. Radially on the inside or radially on the outside, circular-ring-shaped disk 64 is provided with inner toothing or outer toothing (not shown), for example, to form a coupling region.

Radial lines 66, 67, which are also referred to as radials for short, start from a circle center 65. Friction lining pieces 71, 72 are secured on carrier element 63 to form a friction surface in the form of a circular-ring-shaped disk. Friction lining pieces 71, 72 are spaced apart from each other in such a way that grooves are formed between friction lining pieces 71, 72, said grooves extending as far as carrier element 63.

Friction lining pieces 71, 72 are in the shape of rectangles. The rectangles are aligned radially and spaced apart uniformly from each other in the circumferential direction. This results in radially extending grooves 74 between friction lining pieces 71, 72, said grooves widening radially outward. This arrangement provides a number of advantages in comparison with a traditional waffle pattern.

The uniform arrangement of the rectangular friction lining pieces 71, 72 results in the same groove pattern over the entire extent of the friction surface. Moreover, the grooving is extended as far as the carrier element, in particular the carrier plate. This has the advantage that the heat capacity of the carrier plate can be used.

The spacings between friction lining pieces 71, 72 advantageously result in a small proportion of grooves, in particular less than fifty percent. The radially outwardly widening or broadening grooves 74 result in gaps which are narrower radially on the inside. This leads to better distribution of the fluid, in particular of the oil, over the extent of the friction surface, in particular before flowing through a clutch.

The wider groove cross sections on the outside offer the advantage that more air can flow radially inward. This results in lower drag torques. Moreover, the rectangular friction lining pieces 71, 72 offer the advantage that there is no waste during production, e.g. by punching.

A friction part 81 having a carrier element 83 is shown in a quarter section in FIG. 4. Carrier element 83 is embodied as a circular-ring-shaped disk 84 made from a steel material, for example. Radially on the inside or radially on the outside, circular-ring-shaped disk 84 is provided with inner toothing or outer toothing (not shown), for example, to form a coupling region.

Radial lines 86, 87, which are also referred to as radials for short, start from a circle center 5. Friction lining pieces 91, 92 are secured on carrier element 83 to form a friction surface in the form of a circular-ring-shaped disk. Friction lining pieces 91, 92 are spaced apart from each other in such a way that grooves are formed between friction lining pieces 91, 92, said grooves extending as far as carrier element 83.

Friction lining pieces 91, 92 are aligned radially in the longitudinal direction thereof and are in the shape of isosceles trapezoids. The isosceles trapezoids widen radially outward in such a way that grooves 94 between friction lining pieces 91, 92 narrow radially outward. The trapezoidal friction lining pieces 91, 92 provide a number of advantages over a traditional waffle pattern.

On the one hand, the same groove pattern can be achieved over the entire extent of the friction surface. The grooving as far as carrier element 94 offers the advantage that the heat capacity of a carrier plate can be used. Moreover, a small proportion of grooves, in particular a proportion of grooves which is less than fifty percent, can be achieved in a simple manner with the trapezoidal friction lining pieces 91, 92.

By virtue of the tapering of the radial grooves 94, less air enters the channels, and this may have an advantageous effect on cooling. The tapering grooves advantageously ensure a buildup of the fluid, in particular of the oil, in the grooves 94. As a result, a “centrifugal oil pressure” is increased. This leads to easier separation of the clutch plates when the clutch is open. It is thereby possible to achieve lower drag torques in a simple manner.

Moreover, the trapezoidal friction lining pieces 91, 92, which are all of the same size and of identical design, can be produced in a simple manner without waste, e.g. by punching.

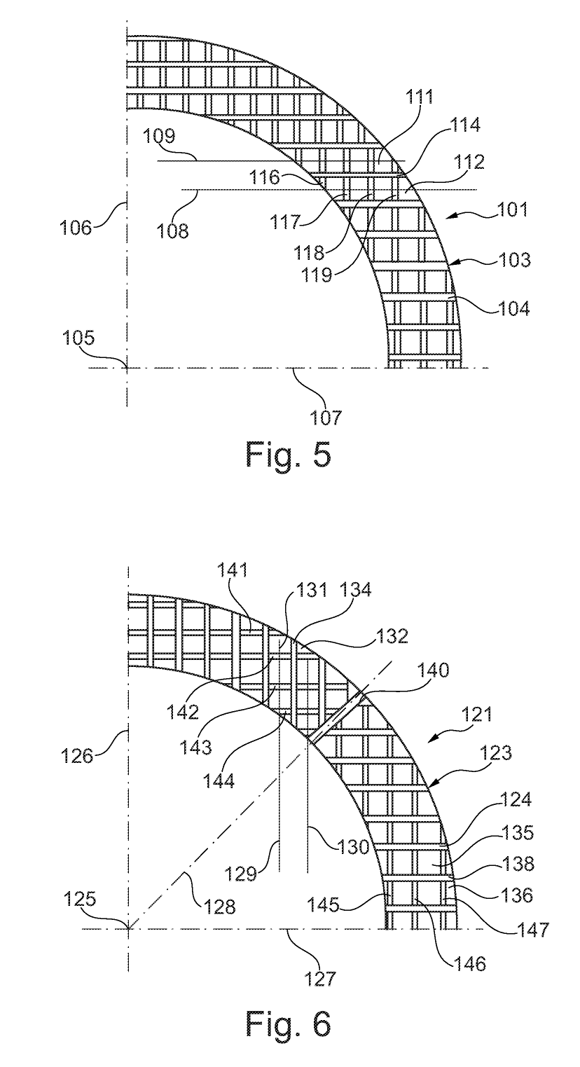

A friction part 101 having a carrier element 103 is shown in a quarter section in FIG. 5. Carrier element 103 is embodied as a circular-ring-shaped disk 104 made from a steel material, for example. Radially on the inside or radially on the outside, circular-ring-shaped disk 104 is provided with inner toothing or outer toothing (not shown), for example, to form a coupling region.

A vertical line 106, which is also referred to as the y axis, starts from a circle center 105. A horizontal line 107, which can also be referred to as the x axis, furthermore starts from circle center 105. Vertical line 106 and horizontal line 107 are also referred to as the vertical and the horizontal for short.

Friction lining pieces 111, 112 are secured on carrier element 103 to form a friction surface in the form of a circular-ring-shaped disk. Friction lining pieces 111, 112 are spaced apart from each other in such a way that grooves are formed between friction lining pieces 111, 112, said grooves extending as far as carrier element 103.

Friction lining pieces 111, 112 are aligned along lines 108, 109, which extend parallel to horizontal 107. A groove 114, which likewise extends parallel to horizontal 107, is in each case formed between friction lining pieces 111, 112. This results in a multiplicity of grooves, of which only groove 114 is provided with a reference sign in FIG. 5 and which all extend in the horizontal direction. The grooves 114 extend as far as carrier element 103.

Moreover, friction lining pieces 111, 112 are provided with grooves 116 to 119, which extend perpendicularly to horizontal 107, i.e. parallel to vertical 106. Grooves 116 to 119 are introduced into friction lining pieces 111, 112 by imprinting, for example. However, grooves 116 to 119 do not extend as far as carrier element 103.

A friction part 121 having a carrier element 123 is shown in a quarter section in FIG. 6. Carrier element 123 is embodied as a circular-ring-shaped disk 124 made from a steel material, for example. Radially on the inside or radially on the outside, circular-ring-shaped disk 124 is provided with inner toothing or outer toothing (not shown), for example, to form a coupling region.

A vertical line 126, which is also referred to as the y axis, starts from a circle center 125. A horizontal line 127, which can also be referred to as the x axis, furthermore starts from circle center 125. Vertical line 126 and horizontal line 127 are also referred to as the vertical and the horizontal for short.

Friction lining pieces 131, 132 are secured on carrier element 123 to form a friction surface in the form of a circular-ring-shaped disk. Friction lining pieces 131, 132 are spaced apart from each other in such a way that grooves are formed between friction lining pieces 131, 132, said grooves extending as far as carrier element 123.

The friction part 121 shown in a quarter section in FIG. 6 is divided once again by a radial 128 into a lower and an upper region. In the upper region, friction lining pieces 131, 132 are aligned in the longitudinal direction thereof along lines 129, 130, which extend parallel to vertical 126. The upper region having friction lining pieces 131, 132 is divided from the lower region by a radial groove 140. Groove 140 extends along radial 128.

A groove 134, which likewise extends parallel to the vertical 126, is in each case formed between friction lining pieces 131, 132.

In the lower region, friction lining pieces 135, 136 are aligned parallel to lines which are not shown specifically and which, once again, extend parallel to the horizontal 127. A groove 138, which likewise extends parallel to the horizontal 127, is in each case formed between friction lining pieces 135, 136.

The friction lining pieces 131, 132 in the upper region of the friction part 121 in FIG. 6 are additionally provided with grooves 141 to 144. However, grooves 141 to 144 do not extend as far as carrier element 123. Grooves 141 to 144 are produced in friction lining piece 131 by imprinting, for example. In this case, grooves 141 to 144 are arranged parallel to the horizontal 127. This ensures that the imprinted grooves extend more in the circumferential direction than in the radial direction. As an alternative, the imprinted grooves can be arranged fully in the circumferential direction. Another variant includes arranging the imprinted grooves in a spiral. This ensures better circumferential alignment of the imprinted grooves as compared with parallel arrangement to the horizontal 127 while simultaneously transferring frictional energy over the entire friction ring surface.

The friction lining pieces 135, 136 in the lower region are likewise provided with grooves 145 to 147. Here, grooves 145 to 147 are arranged parallel to the vertical 126. Grooves 145 to 147 are produced by imprinting, for example, and do not extend as far as carrier element 123.

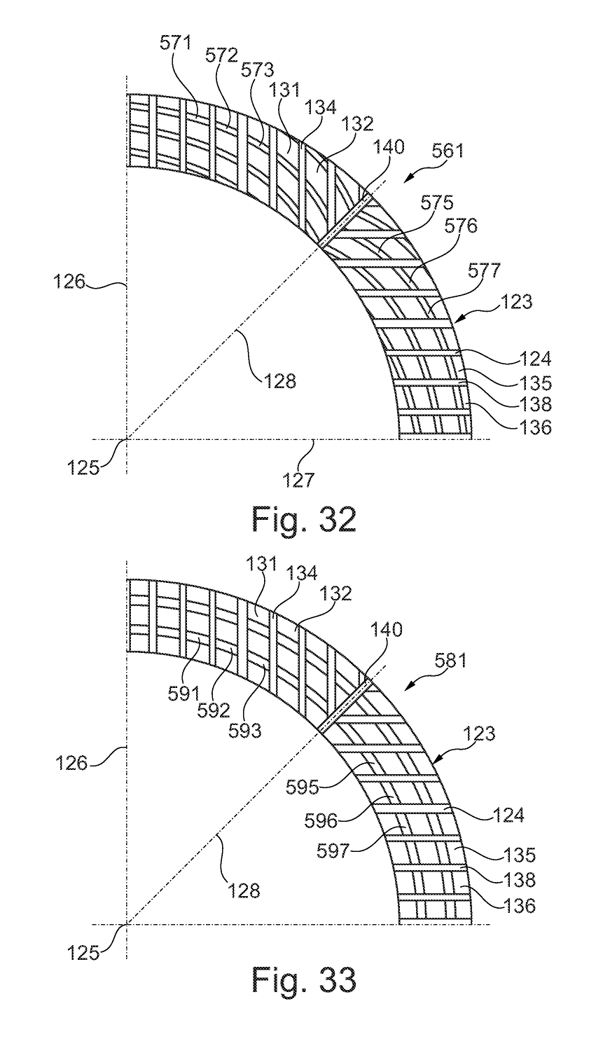

FIGS. 32 and 33 show two friction parts 561, 581, which are similar to the friction part 121 from FIG. 6. To designate identical or similar parts, the same reference signs are used in FIGS. 32 and 33 as in FIG. 6. To avoid repetitions, attention is drawn to the previous description of FIG. 6. In the text which follows, it is primarily the differences between the friction part 121 in FIG. 6 and the friction parts 561, 581 in FIGS. 32 and 33 which are explored. The friction parts 561, 581 in FIGS. 32 and 33 have a different imprint from the friction part 121 in FIG. 6.

The imprint of the friction lining pieces comprises grooves 571, 572, 573 which are arranged along a curved line. The curved linear path is in each case interrupted by the grooves 134 between friction lining pieces 131, 132.

The imprint furthermore comprises grooves 575, 576, 577, which are likewise arranged along a curved line. The curved lines of the groove imprint each start from radial 128. Starting from radial 128, the curved lines extend obliquely radially outward.

In the case of the friction part 581 shown in FIG. 33, the imprinted grooves 591 to 593 and 595 to 597 are arranged along a circumferential line. In FIG. 33, the groove imprint results in two circumferential grooves, which are each interrupted by grooves 134, 138 between the friction lining pieces.

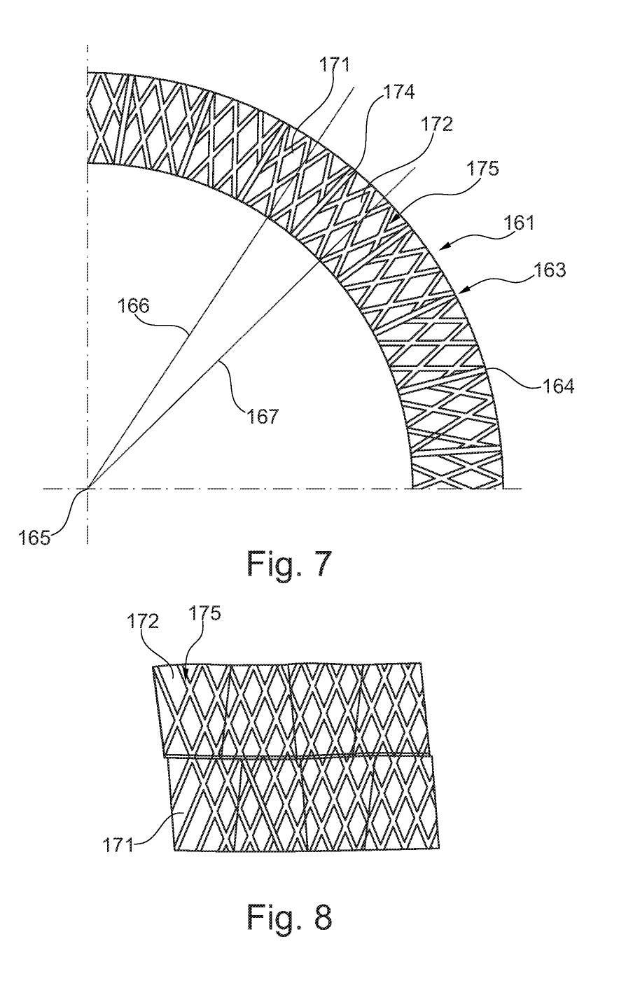

A friction part 161 having a carrier element 163 is shown in a quarter section in FIGS. 7 and 8. Carrier element 163 is embodied as a circular-ring-shaped disk 164 made from a steel material, for example. Radially on the inside or radially on the outside, circular-ring-shaped disk 164 is provided with inner toothing or outer toothing (not shown), for example, to form a coupling region.

Radial lines 166, 167, which are also referred to as radials for short, start from a circle center 165. Friction lining pieces 171, 172 are secured on carrier element 163 to form a friction surface in the form of a circular-ring-shaped disk. Friction lining pieces 171, 172 are spaced apart from each other in such a way that grooves are formed between friction lining pieces 171, 172, said grooves extending as far as carrier element 163.

Friction lining pieces 171, 172 are aligned radially in the longitudinal direction thereof. This means that a longitudinal axis of friction lining pieces 171, 172 in each case coincides with one of the radials 166, 167. Here, friction lining pieces 171, 172 are spaced apart from each other in the circumferential direction in such a way that a groove 174 is formed between the two friction lining pieces 171, 172.

Groove 174 extends as far as carrier element 163. The mutually facing lateral boundary lines of friction lining pieces 171, 172 are arranged parallel to each other, with the result that groove 174 has a constant groove width. It is the extent of groove 174 in the circumferential direction which is referred to as the groove width. Friction lining pieces 171, 172 are all embodied in the same way.

In FIG. 8, it can be seen how friction lining pieces 171, 172 can be produced in a simple manner without waste, e.g. by punching. After punching, friction lining pieces 171, 172 are simply adhesively bonded onto carrier element 163, for example.

The individual friction lining pieces 171, 172 are furthermore provided by imprint 175 with further grooves in the form of a conventional waffle pattern. However, the waffle-pattern grooves produced by imprint 175 do not extend as far as carrier element 163.

In FIG. 8, it can be seen that the imprint 175 for producing the additional grooves in friction lining pieces 171, 172 can be rolled in a simple manner, e.g. into a paper lining, before punching. The grooves can also simply be produced by milling before adhesive bonding.

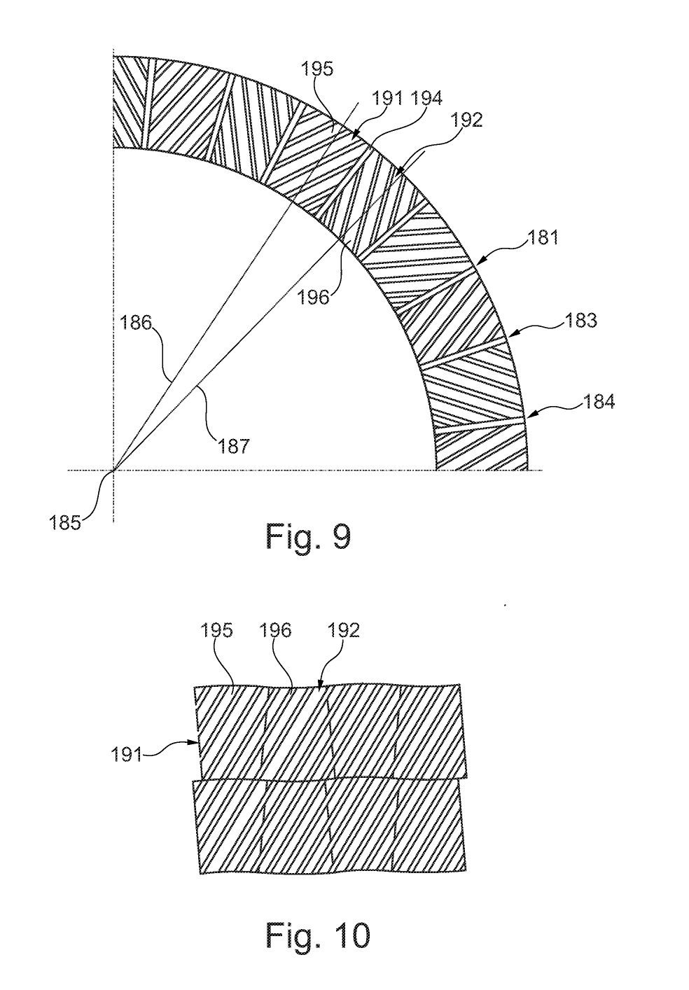

A friction part 911 having a carrier element 193 is shown in a quarter section in FIGS. 9 and 10. Carrier element 193 is embodied as a circular-ring-shaped disk 194 made from a steel material, for example. Radially on the inside or radially on the outside, circular-ring-shaped disk 194 is provided with inner toothing or outer toothing (not shown), for example, to form a coupling region.

Radial lines 186, 187, which are also referred to as radials for short, start from a circle center 195. Friction lining pieces 191, 192 are secured on carrier element 193 to form a friction surface in the form of a circular-ring-shaped disk. Friction lining pieces 191, 192 are spaced apart from each other in such a way that grooves are formed between friction lining pieces 191, 192, said grooves extending as far as carrier element 193.

As in the previous illustrative embodiment, friction lining pieces 191, 192 are aligned radially, i.e. along radials 186, 187. A groove 194, which extends as far as carrier element 183, is in each case formed between two friction lining pieces 191, 192. Groove 194 likewise extends in the radial direction. Friction lining pieces 191, 192 are spaced apart uniformly from each other in the circumferential direction. The grooves 194 between friction lining pieces 191, 192 have a constant groove width.

Moreover, friction lining pieces 191, 192 are provided with different imprints 195, 196 to form further grooves. Imprint 195 comprises grooves in friction lining piece 191, which extend obliquely in an opposite direction to grooves in the imprint 196 of friction lining piece 192. Here, the grooves of imprints 195, 196 are symmetrical with respect to an axis of symmetry which passes through groove 194.

In FIG. 10, it can be seen that friction lining pieces 191, 192 with imprints 195, 196 can be produced in a simple manner, without waste, e.g. by punching.

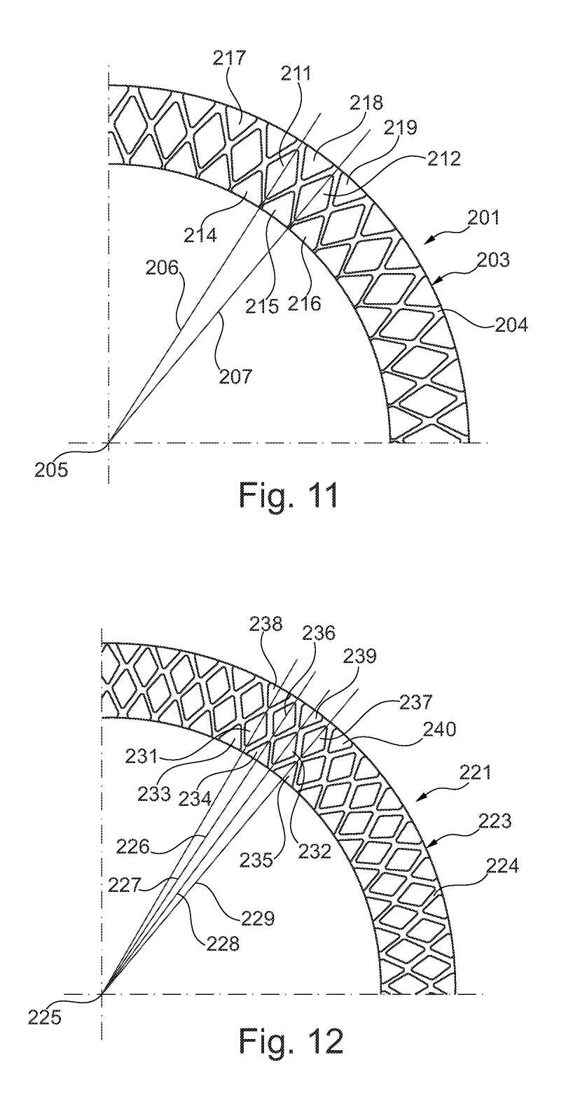

A friction part 201 having a carrier element 203 is shown in a quarter section in FIG. 11. Carrier element 203 is embodied as a circular-ring-shaped disk 204 made from a steel material, for example. Radially on the inside or radially on the outside, circular-ring-shaped disk 204 is provided with inner toothing or outer toothing (not shown), for example, to form a coupling region.

Radial lines 206, 207, which are also referred to as radials for short, start from a circle center 205. Friction lining pieces 211 to 219 are secured on carrier element 203 to form a friction surface in the form of a circular-ring-shaped disk. Friction lining pieces 211 to 219 are spaced apart from each other in such a way that grooves are formed between friction lining pieces 211 to 219, said grooves extending as far as carrier element 203.

Friction lining pieces 211, 212 are in the shape of rhomboids, which are aligned in a radial direction along radials 206, 207. Radially on the inside, rhomboid-segment-shaped or substantially triangular friction lining pieces 214, 215, 216 are arranged in a circumferential row. One of the substantially triangular rhomboid-segment-shaped friction lining pieces 215 is arranged in each case between two of rhomboidal friction lining pieces 211, 212.

Substantially triangular or rhomboid-segment-shaped friction lining pieces 217, 218, 219 are arranged in a circumferential row radially on the outside. In this case, one of the triangular or rhomboid-segment-shaped friction lining pieces 218 is in each case arranged between two rhomboidal friction lining pieces 211, 212.

The vertices of the substantially triangular or rhomboid-segment-shaped friction lining pieces 215, 218 point toward each other. Friction lining piece 215 is bounded radially on the inside by a circular-arc-shaped boundary line. Similarly, friction lining piece 218 is bounded radially on the outside by a circular-arc-shaped boundary line.

The shape and arrangement of friction lining pieces 211, 212 and 214 to 219 results in the same groove pattern over the entire extent of the friction surface, without residual pieces. The spacings between friction lining pieces 211, 212 and 214 to 219 result in grooving as far as carrier element 203.

This offers the advantage that the heat capacity of carrier element 203, which is embodied as a carrier plate for example, can be used. The groove width can be varied, particularly in the radial direction. A kind of nozzle design can thereby be created, for example.

In the circumferential direction, each friction lining piece 211, 212 and 214 to 219 has a kind of nose, thereby simplifying or improving the deflection of fluid, especially oil, during the operation of friction part 201. With friction lining pieces 211, 212 and 214 to 219, it is possible in a simple manner to produce a small proportion of grooves, e.g. of about thirty six percent.

Additional imprinting or milling to form further grooves in friction lining pieces 211, 212 and 214 to 219 is advantageously not required. By virtue of the shape of friction lining pieces 211, 212 and 214 to 219, the lining waste which occurs during production, e.g. due to punching, can be kept low.

A friction part 221 having a carrier element 223 is shown in a quarter section in FIG. 12. Carrier element 223 is embodied as a circular-ring-shaped disk 224 made from a steel material, for example. Radially on the inside or radially on the outside, circular-ring-shaped disk 224 is provided with inner toothing or outer toothing (not shown), for example, to form a coupling region.

Radial lines 226, 227, 228, 229, which are also referred to as radials for short, start from a circle center 225. Friction lining pieces 231 to 240 are secured on carrier element 223 to form a friction surface in the form of a circular-ring-shaped disk. Friction lining pieces 231 to 18 are spaced apart from each other in such a way that grooves are formed between friction lining pieces 231 to 240, said grooves extending as far as carrier element 223.

Friction part 221 comprises rhomboidal friction lining pieces 231, 232 and 236, 237, which are arranged spaced apart from each other in two circumferential rows to form the friction surface. The substantially triangular or rhomboid-segment-shaped friction lining pieces 233 to 235 are arranged in a circumferential row radially on the inside.

The friction lining pieces 233 to 235 of the radially inner circumferential row are bounded radially on the inside by circular-arc-shaped boundary lines. Friction lining pieces 238 to 240 are arranged in a circumferential row radially on the outside and are bounded radially on the outside by circular-arc-shaped boundary lines.

The radially inner vertices of rhomboidal friction lining pieces 231, 232 are in each case arranged between two of friction lining pieces 233, 234 and 234, 235. The radially outer vertices of rhomboidal friction lining pieces 231, 232 point toward the radially inner vertices of friction lining pieces 238, 239. Rhomboidal friction lining pieces 236 are arranged centrally between rhomboidal friction lining pieces 231, 232 and triangular or rhomboid-segment-shaped friction lining pieces 238, 239.

The shape and arrangement of friction lining pieces 231 to 240 advantageously results in the same groove pattern over the entire extent of the friction surface. The grooving may extend as far as carrier element 223. This offers the advantage that the heat capacity of carrier element 223, which may be embodied as a carrier plate, can be used.

The groove width can be varied, in particular to form a nozzle design. In the circumferential direction, each friction lining piece 231 to 240 may have a nose, which can effectively deflect the fluid, in particular oil, during the operation of friction part 221.

By means of a corresponding spacing between friction lining pieces 231 to 240, it is possible to provide a small proportion of grooves, e.g. less than forty percent. Additional imprinting or milling of friction lining pieces 231 to 240 is advantageously not required.

By virtue of the shape of friction lining pieces 231 to 240, the lining waste which arises can be kept low during the production of said faces, e.g. by punching. By virtue of the fine usage network, a good cooling effect can be achieved.

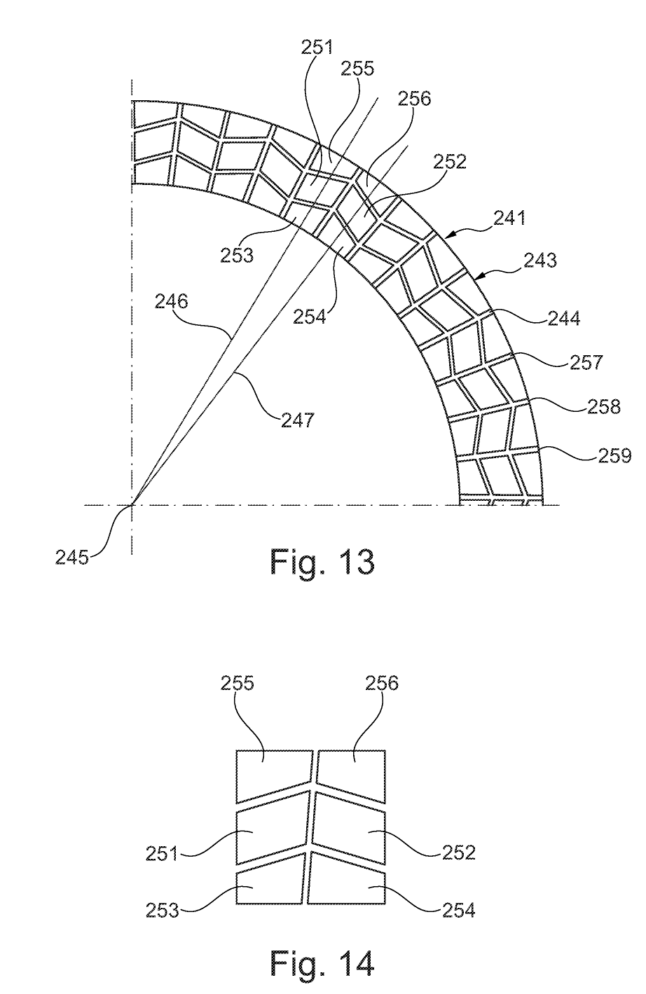

A friction part 241 having a carrier element 243 is shown in a quarter section in FIGS. 13 and 14. Carrier element 243 is embodied as a circular-ring-shaped disk 244 made from a steel material, for example. Radially on the inside or radially on the outside, circular-ring-shaped disk 244 is provided with inner toothing or outer toothing (not shown), for example, to form a coupling region.

Radial lines 246, 247, which are also referred to as radials for short, start from a circle center 245. Friction lining pieces 251 to 256 are secured on carrier element 243 to form a friction surface in the form of a circular-ring-shaped disk. Friction lining pieces 251 to 256 are spaced apart from each other in such a way that grooves are formed between friction lining pieces 251 to 256, said grooves extending as far as carrier element 253. As an alternative, the grooves, which are oriented predominantly in the circumferential direction, can be formed by imprinting.

Friction lining pieces 251 to 256 are aligned radially in groups of three. A first group of three 251 to 253 is aligned along radial 246. A second group of three 254 to 256 is aligned along radial 247. Friction lining pieces 251, 252 are in the shape of parallelograms.

Friction lining pieces 253, 254 are in the shape of parallelogram segments and are bounded radially on the inside by circular-arc-shaped boundary lines. Friction lining pieces 255, 256 are likewise in the shape of parallelogram segments and are bounded radially on the outside by circular-arc-shaped boundary lines.

In FIG. 14, it can be seen that friction lining pieces 251 to 256, which form a repeated unit, can advantageously be produced by punching without punching waste. By virtue of the shape and arrangement of friction lining pieces 251 to 256, the same groove pattern over the entire extent of the friction surface is obtained in a simple manner.

The grooving is advantageously extended as far as carrier element 243, which is advantageously embodied as a carrier plate. This offers the advantage that the heat capacity of the carrier plate can be used.

By virtue of the arrangement and shape of friction lining pieces 251 to 256, a small proportion of grooves, e.g. less than forty percent, can be produced. Moreover, the entire carrier element surface can be used for energy transfer. Friction part 241 advantageously has no circumferential groove at a constant radius.

A radially extending groove 257, 258, 259 is obtained in each case between two of the friction lining pieces arranged in groups of three. The radially extending grooves 257 to 259 are in turn connected by obliquely extending grooves. Here, radially extending groove 257 between the groups of three in each case forms an axis of symmetry for the obliquely extending grooves.

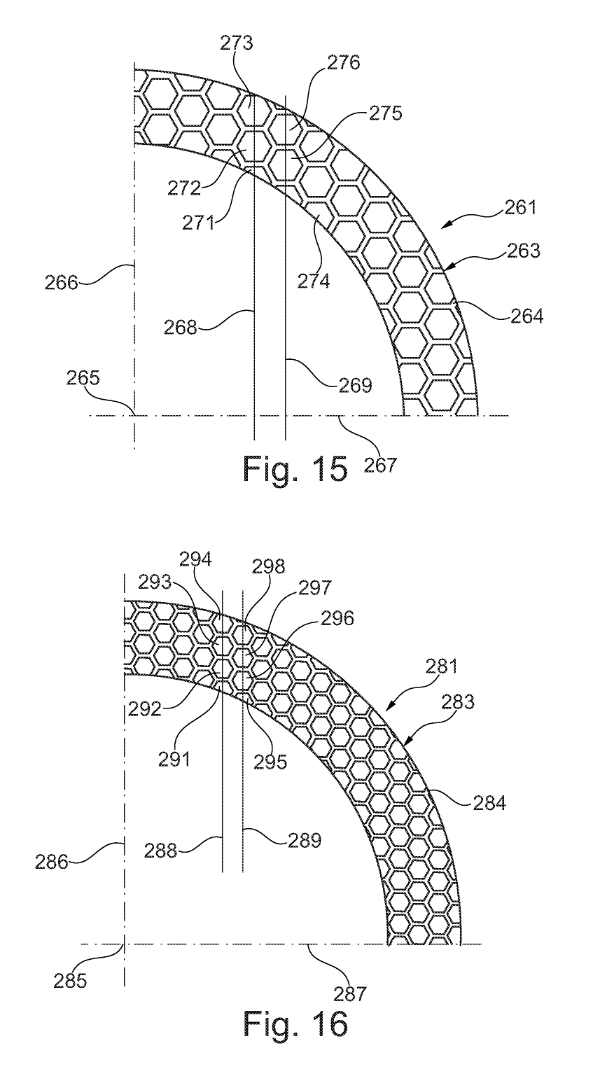

FIGS. 15 to 18 relate to a friction part for a frictionally operating device, having friction lining pieces, which are spaced apart from each other by grooves in order to create a friction surface in the form of a circular-ring-shaped disk, wherein some or all of the friction lining pieces are in the shape of hexagons or hexagon segments.

An illustrative embodiment of the friction part is characterized in that the friction part has the same groove pattern over the entire extent thereof. Uniform flow through the grooves during the operation of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment of the friction part is characterized in that the hexagonal friction lining pieces are arranged in parallel rows. This arrangement results in a friction surface having friction lining pieces which are in the shape of complete hexagons and of hexagon segments. The friction lining pieces are also referred to as friction lining pads. The friction lining pads are also referred to simply as pads for short.

Another illustrative embodiment of the friction part is characterized in that the parallel rows are spaced apart uniformly from each other. The spacings between the individual friction lining pieces may be likewise constant. The friction lining pieces are also referred to as friction lining pads. The friction lining pads are also referred to simply as pads for short.

Another illustrative embodiment of the friction part is characterized in that at least two complete hexagons are arranged in each of the parallel rows. It is thereby possible in a simple manner to form a large number of deflection points for the fluid, in particular oil. This leads to a longer dwell time in the multiplate pack. This improves the cooling capacity.

Another illustrative embodiment of the friction part is characterized in that a maximum of twenty complete hexagons are arranged in the parallel rows. This value has proven advantageous in tests carried out in the context of the present disclosure.

Another illustrative embodiment of the friction part is characterized in that the friction surface comprises at least one complete hexagon in the radial direction. This has proven advantageous in studies carried out in the context of the present disclosure.

Another illustrative embodiment of the friction part is characterized in that the hexagonal friction lining pieces are arranged in radially extending rows. This has proven advantageous in respect of the suitability of the friction lining pieces for production.

Another illustrative embodiment of the friction part is characterized in that the radially extending grooves are spaced apart uniformly from each other in the circumferential direction. This further improves the functionality of the friction part.

Another illustrative embodiment of the friction part is characterized in that at least two complete hexagons are arranged in each of the radially extending rows. This has proven advantageous in studies carried out in the context of the present disclosure. The arrangement of at least two complete hexagons in the radially extending rows is advantageous in respect of the cooling effect because the two complete hexagons ensure a multiplicity of deflections of the cooling fluid.

Another illustrative embodiment of the friction part is characterized in that a number of hexagonal or hexagon-segment-shaped friction lining pieces is arranged in a unit which is repeated in the circumferential direction. In this case, it is advantageous if more than five hexagonal friction lining pieces are arranged in the repeated unit. In an illustrative embodiment, precisely seven hexagonal or hexagon-segment-shaped friction lining pieces are arranged in the unit which is repeated in the circumferential direction.

Another illustrative embodiment of the friction part is characterized in that the hexagonal friction lining pieces are of substantially the same size. This further simplifies the production of the friction part, in particular the friction lining pieces.

A friction part 261; 281 having a carrier element 263; 283 is shown in a quarter section in FIGS. 15 and 16. Carrier element 263; 283 is embodied as a circular-ring-shaped disk 264; 284 made from a steel material, for example. Radially on the inside or radially on the outside, circular-ring-shaped disk 264; 284 is provided with inner toothing or outer toothing (not shown), for example, to form a coupling region.

A vertical line 266; 286, which is also referred to as the y axis, starts from a circle center 265; 285. A horizontal line 267; 287, which can also be referred to as the x axis, furthermore starts from the circle center 265; 285. The vertical line 266; 286 and the horizontal line 267; 287 are also referred to as the vertical and the horizontal for short.

Friction lining pieces 271, 272; 291, 292 are secured on carrier element 263; 283 to form a friction surface in the form of a circular-ring-shaped disk. Friction lining pieces 271, 272; 291, 292 are spaced apart from each other in such a way that grooves are formed between friction lining pieces 271, 272; 291, 292, said grooves extending as far as carrier element 263; 283.

Hexagonal and hexagon-segment-shaped friction lining pieces 271 to 276 offer the advantage, especially over a traditional waffle pattern, that the grooving of the friction surface does not have any sharp corners. By virtue of the hexagon shape, all the corners in the grooving of the friction surface have an angle of one hundred and twenty degrees. This results in particularly stable and robust grooving. The grooving maymay extend as far as carrier element 263, which may be embodied as a carrier plate. This offers the advantage that the heat capacity of the carrier plate can be used.

The arrangement in FIG. 15 is a simple way of enabling a small proportion of grooves, in particular a proportion of grooves which is less than or equal to thirty percent. This offers the advantage that imprinting or milling of friction lining pieces 271 to 276 can be eliminated. By means of the hexagonal shape of the friction lining pieces, a large number of deflection points for the fluid, in particular oil, can be formed in a simple manner. This results in a longer dwell time in the multiplate pack. This has a positive effect on the cooling of the multiplate pack.

The friction lining pieces are also referred to as friction lining pads. The friction lining pads are also referred to simply as pads for short. Friction lining pieces 271 to 273 are arranged along line 268. Friction lining pieces 274 to 276 are arranged along line 269.

In FIG. 16, hexagonal and hexagon-segment-shaped friction lining pieces 291 to 294 are arranged along line 288. Hexagonal and hexagon-segment-shaped friction lining pieces 295 to 298 are arranged along line 289.

The arrangement shown in FIG. 16 results in advantages over the traditional waffle pattern. In particular, the hexagonal shape of friction lining pieces 291 to 298 offers the advantage that the grooving of the friction surface does not have any sharp corners. The hexagonal shape makes it possible to embody all the corners with a one hundred and twenty degree angle. This results in stable and robust grooving of the friction surface.

Moreover, the grooving maymay extend as far as carrier element 283, which may be embodied as a carrier plate. This offers the advantage that the heat capacity of the carrier plate can be used. Moreover, it is possible, with the arrangement shown in FIG. 16, to achieve a small proportion of grooves, which is, in particular, less than or equal to forty percent. As a result, additional imprinting or milling of friction lining pieces 291 to 298 can be eliminated.

The hexagonal shape of friction lining pieces 291 to 298 results in a large number of deflection points for the fluid, in particular oil. This results in a longer dwell time in the multiplate pack. This has a positive effect on the cooling of the clutch.

The friction part 281 shown in FIG. 16 has the advantage over the friction part 261 from FIG. 15 that the groove network is finer. This results in a better cooling effect. In addition, the smaller friction lining pieces 291 to 298 have a lower tendency to upward float.

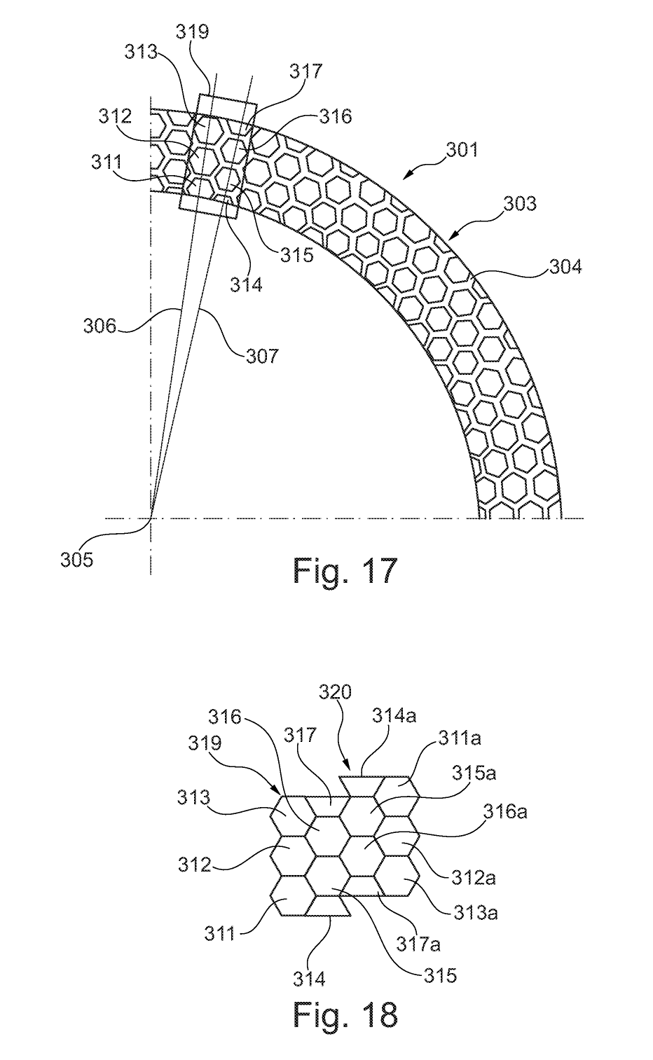

A friction part 301 having a carrier element 303 is shown in a quarter section in FIGS. 17 and 18. Carrier element 303 is embodied as a circular-ring-shaped disk 304 made from a steel material, for example. Radially on the inside or radially on the outside, circular-ring-shaped disk 304 is provided with inner toothing or outer toothing (not shown), for example, to form a coupling region.

Radial lines 306, 307, which are also referred to as radials for short, start from a circle center 305. Friction lining pieces 311 to 317 are secured on carrier element 303 to form a friction surface in the form of a circular-ring-shaped disk. Friction lining pieces 311 to 317 are spaced apart from each other in such a way that grooves are formed between friction lining pieces 311 to 317, said grooves extending as far as carrier element 303.

In FIG. 17, the hexagonal and hexagon-segment-shaped friction lining pieces 311 to 317 are aligned radially. Friction lining pieces 311 to 313 are arranged on radial 306. Friction lining pieces 314 to 317 are arranged on radial 307. In this case, friction lining pieces 311 to 317 are arranged in a unit 319 which is repeated in the circumferential direction.

The arrangement in the repeated unit 319 offers the advantage that small residual pieces are not formed during the production of friction lining pieces 311 to 317. In FIG. 17, the groove pattern is advantageously rotationally symmetrical. The result is that the hexagons increase in size with the radius.

In FIG. 18, two repeated units 319, 320, each having seven friction lining pieces 311 to 317 and 311a to 317a, are used to show that said friction lining pieces can be punched almost without waste. This considerably simplifies the production of the friction lining pieces and of friction part 301.

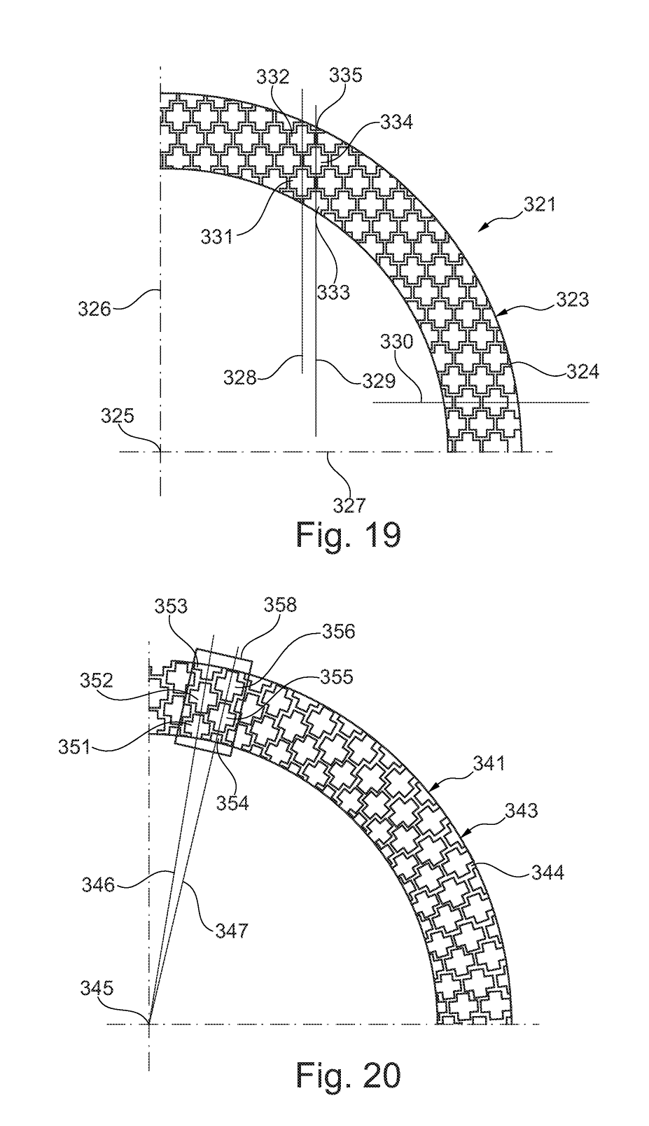

FIGS. 19 and 20 relate to a friction part for a frictionally operating device, having friction lining pieces, which are spaced apart from each other by grooves in order to create a friction surface in the form of a circular-ring-shaped disk, wherein some or all of the friction lining pieces are in the shape of crosses or cross segments.

A illustrative embodiment of the friction part is characterized in that the friction part has the same groove pattern over the entire extent thereof. Uniform flow through the grooves during the operation of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment of the friction part is characterized in that the cross-shaped or cross-segment-shaped friction lining pieces are arranged in parallel rows. It is thereby possible in a simple matter to form extremely frequent deflection points for the fluid, in particular oil. This leads to a relatively low flow rate, thereby optimizing cooling.

Another illustrative embodiment of the friction part is characterized in that the parallel rows are spaced apart uniformly from each other. This results in a uniform groove pattern. The cross-shaped or cross-segment-shaped friction lining pieces are advantageously spaced apart uniformly from each other.

Another illustrative embodiment of the friction part is characterized in that at least one complete cross is arranged in each of the parallel rows. This further improves the functionality of the friction part.

Another illustrative embodiment of the friction part is characterized in that a maximum of ten complete crosses is arranged in each of the parallel rows. This number has proven advantageous in studies carried out in the context of the present disclosure.

Another illustrative embodiment of the friction part is characterized in that the friction surface comprises at least one complete cross in the radial direction. This further improves the functionality of the friction part.

Another illustrative embodiment of the friction part is characterized in that the cross-shaped or cross-segment-shaped friction lining pieces are arranged in radially extending rows. This further simplifies the production of the friction lining pieces.

Another illustrative embodiment of the friction part is characterized in that the cross-shaped friction lining pieces have very rounded edges. This simplifies production and reduces the risk that individual corners of a pad or an entire part will become detached.

Another illustrative embodiment of the friction part is characterized in that the radially extending rows are spaced apart uniformly from each other in the circumferential direction. This results in the same groove pattern over the entire extent of the friction surface.

Another illustrative embodiment of the friction part is characterized in that at least one complete cross is arranged in each of the radially extending rows. This further improves the cooling effect.

Another illustrative embodiment of the friction part is characterized in that a number of cross-shaped or cross-segment-shaped friction lining pieces is arranged in units which are repeated in the circumferential direction. This offers the advantage that the friction lining pieces can be produced, in particular punched, almost without lining waste. More than five, e.g. six, cross-shaped or cross-segment-shaped friction lining pieces may be arranged in the repeated unit.

Another illustrative embodiment of the friction part is characterized in that the cross-shaped friction lining pieces are of substantially the same size. This further simplifies the production of the friction lining pieces.

A friction part 321 having a carrier element 323 is shown in a quarter section in FIG. 19. Carrier element 323 is embodied as a circular-ring-shaped disk 324 made from a steel material, for example. Radially on the inside or radially on the outside, circular-ring-shaped disk 324 is provided with inner toothing or outer toothing (not shown), for example, to form a coupling region.

A vertical line 326, which is also referred to as the y axis, starts from a circle center 325. A horizontal line 327, which can also be referred to as the x axis, furthermore starts from the circle center 325. The vertical line 326 and the horizontal line 327 are also referred to as the vertical and the horizontal for short.

Friction lining pieces 331 to 335 are secured on carrier element 323 to form a friction surface in the form of a circular-ring-shaped disk. Friction lining pieces 331 to 335 are spaced apart from each other in such a way that grooves are formed between friction lining pieces 331 to 335, said grooves extending as far as carrier element 323.

In FIG. 19, the cross-shaped or cross-segment-shaped friction lining pieces 331 to 335 are arranged on lines 328 and 329. Lines 329 and 329 extend parallel to the vertical 326 and are spaced apart from each other uniformly, resulting in uniform grooving with a constant groove width over the entire friction surface. Friction lining pieces 331 and 332 are arranged on line 328. Friction lining pieces 333 and 334 are arranged on line 329. Friction lining pieces which are not designated specifically are arranged on line 330, which extends parallel to horizontal 327.

The grooving maymay extend as far as carrier element 323, which is advantageously embodied as a carrier plate. The grooving as far as the carrier plate makes it possible to use the heat capacity of the plate.

Moreover, it is possible, with the arrangement shown in FIG. 19, to achieve a small proportion of grooves, which is, for example, less than or equal to forty percent. This offers the advantage that imprinting or milling of friction lining pieces 331 to 335 can be eliminated. By means of the cross-shaped configuration of the friction lining pieces, extremely frequent oil deflections can be achieved in a simple manner. This reduces the flow rate of the fluid, in particular of the oil. This improves the cooling effect.

By virtue of the parallel arrangement, the cross-shaped or cross-segment-shaped friction lining pieces 331 to 335 can be produced, in particular punched, almost without lining waste.

A friction part 341 having a carrier element 343 is shown in a quarter section in FIG. 20. Carrier element 343 is embodied as a circular-ring-shaped disk 344 made from a steel material, for example. Radially on the inside or radially on the outside, circular-ring-shaped disk 344 is provided with inner toothing or outer toothing (not shown), for example, to form a coupling region.

Radial lines 346, 347, which are also referred to as radials for short, start from a circle center 335. Friction lining pieces 351 to 356 are secured on carrier element 343 to form a friction surface in the form of a circular-ring-shaped disk. Friction lining pieces 351 to 356 are spaced apart from each other in such a way that grooves are formed between friction lining pieces 351 to 356, said grooves extending as far as carrier element 343.

In FIG. 20, the cross-shaped or cross-segment-shaped friction lining pieces 351 to 335 are aligned radially. Friction lining pieces 351 to 353 are arranged on radial 346. Friction lining pieces 354 to 356 are arranged on radial 347. Friction lining pieces 351 to 356 are spaced apart from each other uniformly, resulting in uniform grooving with a constant groove width over the entire friction surface.

Friction lining pieces 351 to 356 are arranged in a repeated unit 358. This is advantageous, especially over a traditional waffle pattern. By means of the cross-shaped or cross-segment-shaped friction lining pieces 351 to 356, the same groove pattern can be created in a simple manner over the entire extent of the friction surface. The grooving maymay extend as far as carrier element 343, which is advantageously embodied as a carrier plate. The grooving as far as the carrier plate makes it possible to use the heat capacity of the plate.

Moreover, it is possible, with the arrangement shown in FIG. 20, to achieve a small proportion of grooves, which is, for example, less than or equal to forty percent. This offers the advantage that imprinting or milling of friction lining pieces 351 to 356 can be eliminated. By means of the cross-shaped configuration of the friction lining pieces, extremely frequent oil deflections can be achieved in a simple manner. This reduces the flow rate of the fluid, in particular of the oil. This improves the cooling effect.

By virtue of the radial alignment and the arrangement in the repeated unit 358, the cross-shaped or cross-segment-shaped friction lining pieces 351 to 356 can be produced, in particular punched, almost without lining waste.

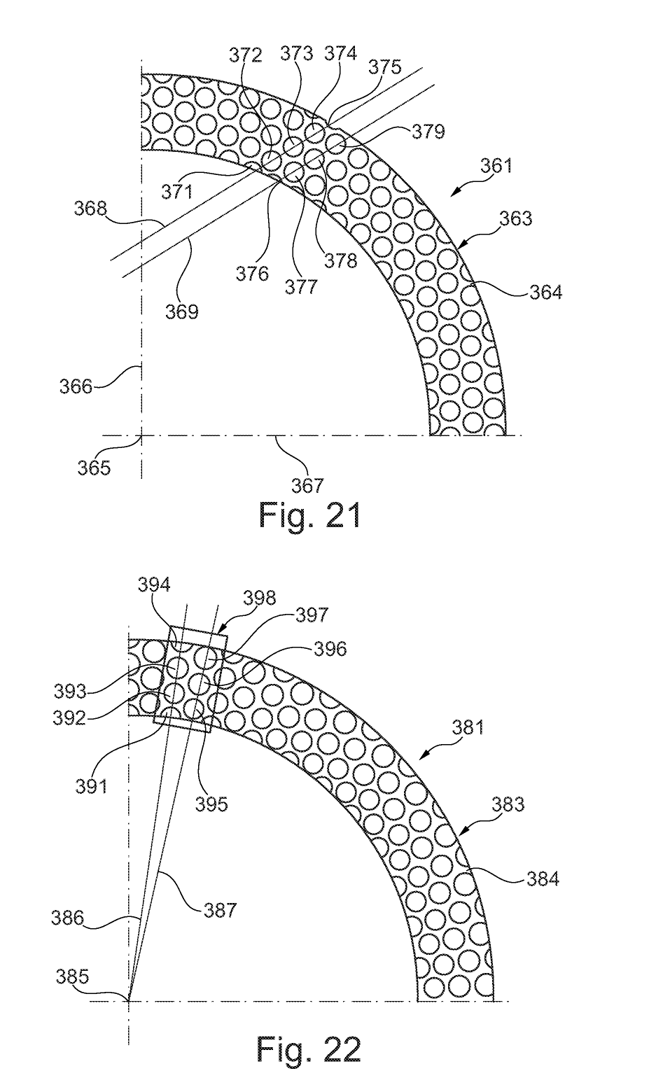

FIGS. 21 to 28 relate to a friction part for a frictionally operating device, having friction lining pieces, which are spaced apart from each other by grooves in order to create a friction surface in the form of a circular-ring-shaped disk, wherein some or all of the friction lining pieces are in the shape of circles and/or circular segments.

An illustrative embodiment of the friction part is characterized in that the friction part has the same groove pattern over the entire extent thereof. Uniform flow through the grooves during the operation of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment of the friction part is characterized in that the circular and/or circular-segment-shaped friction lining pieces are arranged in parallel rows. By means of this arrangement, a uniform groove pattern with a large number of deflections is obtained in a simple manner.

Another illustrative embodiment of the friction part is characterized in that the parallel rows are spaced apart uniformly from each other. This further improves the functionality of the friction part.

Another illustrative embodiment of the friction part is characterized in that at least two complete circles are arranged in each of the parallel rows. This number has proven advantageous in studies carried out in the context of the present disclosure.

Another illustrative embodiment of the friction part is characterized in that a maximum of four complete circles is arranged in each of the parallel rows. This number too has proven advantageous in studies carried out in the context of the present disclosure.

Another illustrative embodiment of the friction part is characterized in that the friction surface comprises at least two complete circles in the radial direction. An adequate cooling effect is thereby ensured in a simple manner.

Another illustrative embodiment of the friction part is characterized in that the circular and/or circular-segment-shaped friction lining pieces are arranged in radially extending rows. Advantages in respect of the suitability of the friction part for production are thereby obtained.

Another illustrative embodiment of the friction part is characterized in that the radially extending rows are spaced apart uniformly from each other in the circumferential direction. The creation of a uniform or identical groove pattern in the circumferential direction is thereby made possible in a simple manner.

Another illustrative embodiment of the friction part is characterized in that at least two complete circles are arranged in each of the radially extending rows. This number has proven advantageous in the studies carried out in the context of the present disclosure.

Another illustrative embodiment of the friction part is characterized in that a number of circular and/or circular-segment-shaped friction lining pieces is arranged in units which are repeated in the circumferential direction. This considerably simplifies the production of the friction part.

Another illustrative embodiment of the friction part is characterized in that the circular and/or circular-segment-shaped friction lining pieces are of substantially the same size. This has a positive effect on the groove pattern, the suitability for production and the functionality of the friction part.

Another illustrative embodiment of the friction part is characterized in that the circular and/or circular-segment-shaped friction lining pieces are arranged along curved lines. This arrangement too has surprisingly proven advantageous in the studies carried out in the context of the present disclosure.

Another illustrative embodiment of the friction part is characterized in that the curved lines are in the shape of elliptical arcs. The configuration of the elliptical arcs maymay relate to one and the same ellipse. Here, the elliptical arcs may be associated with a principal axis of the ellipse.

Another illustrative embodiment of the friction part is characterized in that the curved lines are parallel to each other. The groove pattern is thereby made uniform in a simple manner.

Another illustrative embodiment of the friction part is characterized in that the curved lines are spaced apart uniformly from each other. The creation of the same groove pattern in the circumferential direction is thereby made possible in a simple manner.

Another illustrative embodiment of the friction part is characterized in that at least four complete circles are arranged along a curved line. This number has proven advantageous in the studies carried out in the context of the present disclosure.

Another illustrative embodiment of the friction part is characterized in that a maximum of four complete circles is arranged along a curved line. This number too has proven advantageous in the studies carried out in the context of the present disclosure.

Another illustrative embodiment of the friction part is characterized in that the friction part has a plurality of circular and/or circular-segment-shaped friction lining pieces arranged in at least one circumferential row. The term “circumferential row” is used to designate a row in which the circular and/or circular-segment-shaped friction lining pieces are arranged on a circumferential line or a pitch circle. A diameter of the pitch circle is greater than an inside diameter and less than an outside diameter of the friction surface.

Another illustrative embodiment of the friction part is characterized in that, in at least one circumferential row, one circular friction lining piece is in each case arranged in a radial direction between an inner end piece and an outer end piece. The creation of radial grooves in the friction surface of the friction part is thereby made possible in a simple manner. A circular-arc-shaped groove can advantageously be formed between the inner end piece and the circular friction lining piece. A circular-arc-shaped groove of the same kind can likewise be formed between the outer end piece and the circular friction lining piece.

Another illustrative embodiment of the friction part is characterized in that the inner end pieces and the outer end pieces each have a circular-arc-shaped recess which faces the circular friction lining piece. This simplifies the formation of the circular-arc-shaped grooves between the end pieces and the circular friction lining piece.

Another illustrative embodiment of the friction part is characterized in that the inner end piece/outer end piece has a circular-arc-shaped boundary line radially on the inside/outside. The formation of a circular-arc-shaped friction surface is thereby made possible in a simple manner.

Another illustrative embodiment of the friction part is characterized in that the inner end piece, the circular friction lining piece and the outer end piece form a unit which is repeated in the circumferential direction. This considerably simplifies the production of the friction part.

Another illustrative embodiment of the friction part is characterized in that a circular-arc-shaped groove is formed between each of the circular friction lining pieces and the end pieces. In each case, the circular-arc-shaped groove connects two radial grooves to each other.

Another illustrative embodiment of the friction part is characterized in that a continuous radial groove is arranged between each two repeated units. It is advantageous if two circular-arc-shaped grooves, in particular four circular-arc-shaped grooves, start from each radial groove.

Another illustrative embodiment of the friction part is characterized in that, in at least one circumferential row, one circular friction lining piece in each case is arranged in a center of two inner end pieces and two outer end pieces. Forced deflection of the fluid, in particular cooling oil, by the grooving is thereby made possible in a simple manner.

Another illustrative embodiment of the friction part is characterized in that the inner end pieces and the outer end pieces each have a circular-arc-shaped recess which faces the circular friction lining piece. It is advantageous if the inner end pieces and the outer end pieces are spaced apart uniformly from the circular friction lining piece.

Another illustrative embodiment of the friction part is characterized in that the inner end pieces/outer end pieces have circular-arc-shaped boundary lines radially on the inside/outside. This simplifies the formation of a friction surface in the form of a circular-ring-shaped disk.

Another illustrative embodiment of the friction part is characterized in that the two inner end pieces, the circular friction lining piece and the two outer end pieces form a unit which is repeated in the circumferential direction. This considerably simplifies the production of the friction part.

Another illustrative embodiment of the friction part is characterized in that a circular friction lining piece is arranged between each two repeated units. The creation of the same groove pattern in the circumferential direction is thereby made possible in a simple manner.

Another illustrative embodiment of the friction part is characterized in that a or the unit which is repeated in the circumferential direction completely or partially comprises four circular friction lining pieces, two inner end pieces, two outer end pieces and a central piece. The two inner end pieces and the two outer end pieces may be embodied in the same way or in a similar way to that described above.

Another illustrative embodiment of the friction part is characterized in that the central piece has four circular-arc-shaped recesses, which face the four circular friction lining pieces. The central piece with the four circular-arc-shaped recesses is substantially in the shape of a cross.

Another illustrative embodiment of the friction part is characterized in that a or the unit which is repeated in the circumferential direction completely or partially comprises three circular friction lining pieces, one inner end piece and two central pieces. The inner end pieces may be embodied in the same way or in a similar way to that described above. The outer end pieces can be omitted.

Another illustrative embodiment of the friction part is characterized in that the central pieces each have four circular-arc-shaped recesses, which face the circular friction lining pieces. The central pieces with the circular-arc-shaped recesses are substantially in the shape of crosses.

Another illustrative embodiment of the friction part is characterized in that a or the unit which is repeated in the circumferential direction completely or partially comprises four circular friction lining pieces and three central pieces. In particular, the repeated unit does not comprise any inner end pieces or any outer end pieces.

Another illustrative embodiment of the friction part is characterized in that the central pieces each have four circular-arc-shaped recesses, which face circular friction lining pieces. The central pieces with the circular-arc-shaped recesses are substantially in the shape of crosses.

Another illustrative embodiment of the friction part is characterized in that the inner end pieces are of identical design. This further simplifies the production of the friction part.

Another illustrative embodiment of the friction part is characterized in that the outer end pieces are of identical design. This further simplifies the production of the friction part.

Another illustrative embodiment of the friction part is characterized in that the central pieces are of identical design. This further simplifies the production of the friction part.

Another illustrative embodiment of the friction part is characterized in that the circular friction lining pieces are of identical design. This further simplifies the production of the friction part.

A friction part 361 having a carrier element 363 is shown in a quarter section in FIG. 21. Carrier element 363 is embodied as a circular-ring-shaped disk 364 made from a steel material, for example. Radially on the inside or radially on the outside, circular-ring-shaped disk 364 is provided with inner toothing or outer toothing (not shown), for example, to form a coupling region.

A vertical line 366, which is also referred to as the y axis, starts from a circle center 365. A horizontal line 367, which can also be referred to as the x axis, furthermore starts from the circle center 365. The vertical line 366 and the horizontal line 367 are also referred to as the vertical and the horizontal for short.

Friction lining pieces 371, 372 are secured on carrier element 363 to form a friction surface in the form of a circular-ring-shaped disk. Friction lining pieces 371, 372 are spaced apart from each other in such a way that grooves are formed between friction lining pieces 371, 372, said grooves extending as far as the carrier element 363.

The circular and circular-segment-shaped friction lining pieces 371 to 379 are aligned parallel to each other. Friction lining pieces 371 to 375 are arranged along line 368. Friction lining pieces 376 to 379 are arranged along line 369. Here, friction lining pieces 371 to 379 are spaced apart uniformly from each other.

The arrangement in FIG. 21 offers advantages over a traditional waffle pattern. One advantage is that the grooving in FIG. 21 does not have any sharp corners and is consequently robust. The grooving may extend as far as carrier element 363. Carrier element 363 is advantageously embodied as a carrier plate. The grooving as far as the carrier element offers the advantage that the heat capacity of the plate can be used. By means of the arrangement in FIG. 21, continuous or frequent changes in groove cross section are obtained in a simple manner. This tends to lead to a turbulent flow of the fluid. A better cooling effect is thereby achieved.

In the circumferential direction, each friction lining piece 371 to 379 has a nose, which can deflect the fluid, in particular oil. By means of the arrangement shown in FIG. 21, a small proportion of grooves, e.g. about forty-two percent, can be produced in a simple manner. Imprinting and/or milling of friction lining pieces 371 to 379 can advantageously be eliminated.

A friction part 381 having a carrier element 383 is shown in a quarter section in FIG. 22. Carrier element 383 is embodied as a circular-ring-shaped disk 384 made from a steel material, for example. Radially on the inside or radially on the outside, circular-ring-shaped disk 384 is provided with inner toothing or outer toothing (not shown), for example, to form a coupling region.

Radial lines 386, 387, which are also referred to as radials for short, start from a circle center 385. Friction lining pieces 391 to 397 are secured on carrier element 383 to form a friction surface in the form of a circular-ring-shaped disk. Friction lining pieces 391 to 397 are spaced apart from each other in such a way that grooves are formed between friction lining pieces 391 to 397, said grooves extending as far as the carrier element 383.

In FIG. 22, the circular and circular-segment-shaped friction lining pieces 391 to 397 are aligned radially. Radially aligned friction lining pieces 391 to 394 are arranged on radial 386. Friction lining pieces 395 to 397 are arranged on radial 387.

Friction lining pieces 391 to 397 are arranged in a unit 398 which is repeated in the circumferential direction. This results in advantages over a traditional waffle pattern.

The radial alignment of friction lining pieces 391 to 397 gives a rotationally symmetrical design. Moreover, the grooving formed does not have any sharp corners. Consequently, the grooving with friction lining pieces 391 to 397 is stable and robust.

In FIG. 22 too, the grooving extends as far as the carrier element 383, which is advantageously embodied as a carrier plate. This offers the advantage that the heat capacity of the plate becomes usable.

The arrangement in FIG. 22 results in a multiplicity of changes in groove cross section. This tends to lead to the formation of a turbulent flow during the operation of friction part 381. This improves the cooling of the multiplate clutch.

In the circumferential direction, each friction lining piece 391 to 397, which is also referred to as a pad, has a nose, which can deflect the fluid, in particular oil. By means of the grooving in FIG. 22 too, a small proportion of grooves, e.g. forty-two percent, can be produced in a simple manner. Imprinting or milling of friction lining pieces 391 to 397 can advantageously be eliminated.

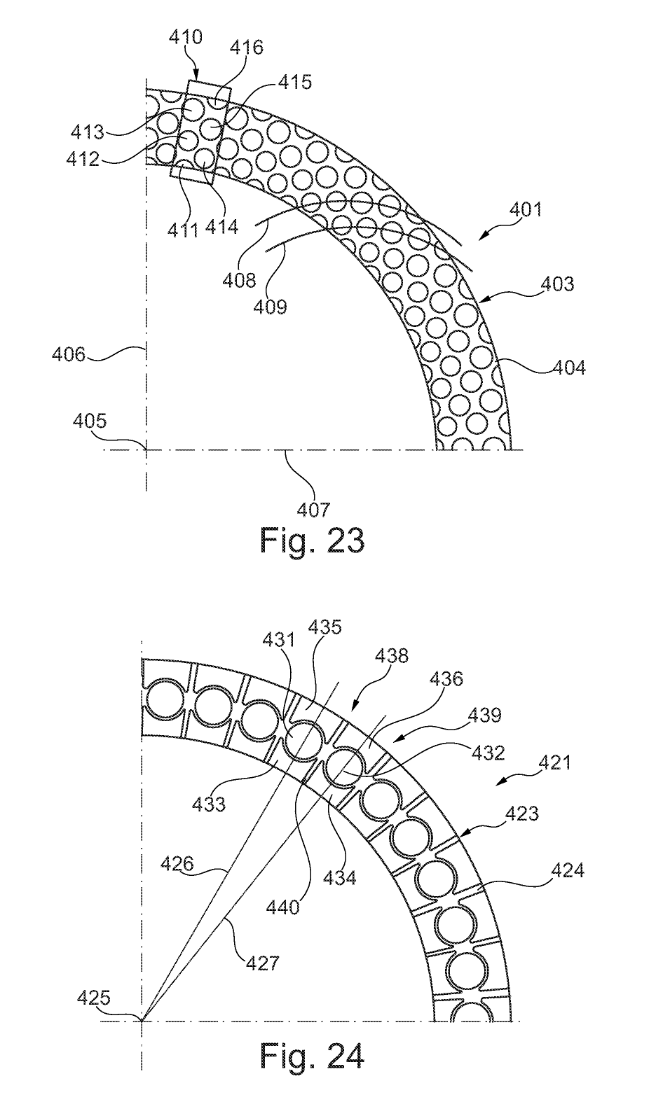

A friction part 401 having a carrier element 403 is shown in a quarter section in FIG. 23. Carrier element 403 is embodied as a circular-ring-shaped disk 404 made from a steel material, for example. Radially on the inside or radially on the outside, circular-ring-shaped disk 404 is provided with inner toothing or outer toothing (not shown), for example, to form a coupling region.

A vertical line 406, which is also referred to as the y axis, starts from a circle center 405. A horizontal line 407, which can also be referred to as the x axis, furthermore starts from the circle center 405. The vertical line 406 and the horizontal line 407 are also referred to as the vertical and the horizontal for short.

Friction lining pieces 411, 412 are secured on carrier element 403 to form a friction surface in the form of a circular-ring-shaped disk. Friction lining pieces 411, 412 are spaced apart from each other in such a way that grooves are formed between friction lining pieces 411, 412, said grooves extending as far as the carrier element 403.

In FIG. 23, the circular and circular-segment-shaped friction lining pieces are arranged along curved lines 408, 409. Curved lines 408, 409 are in the shape of elliptical arcs. Here, curved lines 408, 409 are spaced apart uniformly from each other.

Six circular and circular-segment-shaped friction lining pieces 411 to 416 are arranged in a unit 410 which is repeated in the circumferential direction.

The grooving in FIG. 23 provides an indirect path for radial throughflow. It is thereby possible to achieve a longer dwell time of the fluid, in particular oil, in the region of the friction surface. It is thereby possible to improve the cooling of the multiplate pack.

A friction part 421 having a carrier element 423 is shown in a quarter section in FIG. 24. Carrier element 423 is embodied as a circular-ring-shaped disk 424 made from a steel material, for example. Radially on the inside or radially on the outside, circular-ring-shaped disk 424 is provided with inner toothing or outer toothing (not shown), for example, to form a coupling region.

Radial lines 426, 427, which are also referred to as radials for short, start from a circle center 425. Friction lining pieces 431, 432 are secured on carrier element 423 to form a friction surface in the form of a circular-ring-shaped disk. Friction lining pieces 431, 432 are spaced apart from each other in such a way that grooves are formed between friction lining pieces 431, 432, said grooves extending as far as the carrier element 423.

In FIG. 24, circular friction lining pieces 431, 432 are combined with inner end pieces 433, 434 and with outer end pieces 435, 436. A circular friction lining piece 431; 432 is in each case combined with precisely one inner end piece 433; 434 and one outer end piece 435; 436 in units 438, 439 which are repeated in the circumferential direction.

The repeated unit 431 is arranged along radial 426. Unit 439, which is repeated in the circumferential direction, is arranged along radial 427.

A radial groove 440 is in each case formed between two units 438, 439. A total of four circular-arc-shaped grooves, which are formed between circular friction lining pieces 431, 432 and end pieces 433 to 436, starts from radial groove 440.

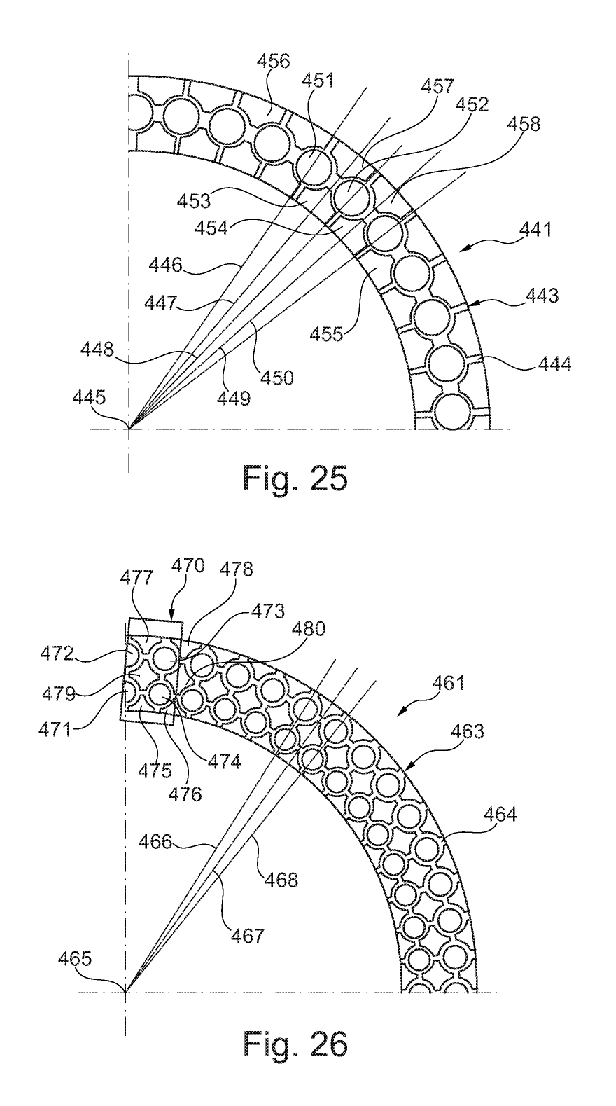

A friction part 441 having a carrier element 443 is shown in a quarter section in FIG. 25. Carrier element 443 is embodied as a circular-ring-shaped disk 444 made from a steel material, for example. Radially on the inside or radially on the outside, circular-ring-shaped disk 444 is provided with inner toothing or outer toothing (not shown), for example, to form a coupling region.

Radial lines 446, 447, 448, 449, 450, which are also referred to as radials for short, start from a circle center 445. Friction lining pieces 451, 452 are secured on carrier element 443 to form a friction surface in the form of a circular-ring-shaped disk. Friction lining pieces 451, 452 are spaced apart from each other in such a way that grooves are formed between friction lining pieces 451, 452, said grooves extending as far as the carrier element 443.

In FIG. 25, circular friction lining pieces 451, 452 are combined with inner end pieces 453, 454, 455 and outer end pieces 456, 457, 458.

Radials 446 to 450 are spaced apart uniformly from each other. Circular friction lining piece 451 is arranged on radial 446. Circular friction lining piece 452 is arranged on radial 448.

Inner end piece 453 and outer end piece 457 are arranged on radial 447. Inner end piece 454 and outer end piece 458 are arranged on radial 449.

Inner end pieces 453, 454 and outer end pieces 457, 458 comprise circular-arc-shaped recesses, which face circular friction lining pieces 451, 452.

A friction part 461 having a carrier element 463 is shown in a quarter section in FIG. 26. Carrier element 463 is embodied as a circular-ring-shaped disk 464 made from a steel material, for example. Radially on the inside or radially on the outside, circular-ring-shaped disk 464 is provided with inner toothing or outer toothing (not shown), for example, to form a coupling region.

Radial lines 466, 467, 468, which are also referred to as radials for short, start from a circle center 465. Friction lining pieces 471 to 474 are secured on carrier element 463 to form a friction surface in the form of a circular-ring-shaped disk. Friction lining pieces 471 to 474 are spaced apart from each other in such a way that grooves are formed between friction lining pieces 471 to 474, said grooves extending as far as the carrier element 3.

In FIG. 26, two circular friction lining pieces in each case are arranged on radials 466, 468. An inner end piece, a central piece and an outer end piece are arranged on radial 467.

Four circular or circular-segment-shaped friction lining pieces 471 to 474 are combined with two inner end pieces 475, 476, two outer end pieces 477, 478 and two central pieces 479, 480 in a unit 470 which is repeated in the circumferential direction. The central pieces 479, 480 are each substantially in the shape of crosses with four circular-arc-shaped recesses, which face friction lining pieces 471 to 474.

Inner end pieces 475, 476 each have two circular-arc-shaped recesses, which face friction lining pieces 471, 474. Outer end pieces 477, 478 likewise each have two circular-arc-shaped recesses, which face friction lining pieces 472, 473.

The grooving in FIG. 26 is rotationally symmetrical. The arrangement of friction lining pieces 471 to 474 and of outer end pieces 475 to 478 and central pieces 479, 480 in repeated unit 470 offers the advantage that no residual pieces are formed during production, e.g. by punching. Moreover, the arrangement of the different friction lining pieces makes it possible in a simple manner to form a large number of fluid deflection points, in particular oil deflection points.

The grooving may extends as far as carrier element 463, which is may embodied as a carrier plate. This offers the advantage that the thermal capacity of the plate becomes usable.

Narrow cross sections at the inside diameter of the friction surface result in better fluid distribution over the extent of the friction surface.

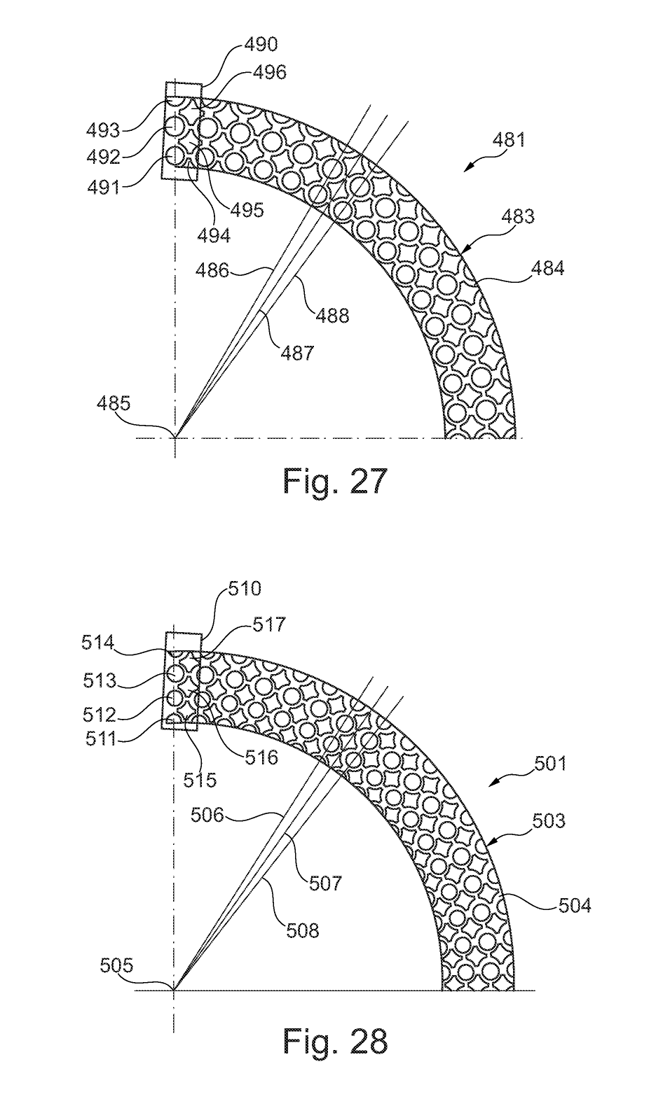

A friction part 481 having a carrier element 483 is shown in a quarter section in FIGS. 27 and 28. Carrier element 483 is embodied as a circular-ring-shaped disk 484 made from a steel material, for example. Radially on the inside or radially on the outside, circular-ring-shaped disk 484 is provided with inner toothing or outer toothing (not shown), for example, to form a coupling region.

Radial lines 486, 487, 488, which are also referred to as radials for short, start from a circle center 485. Friction lining pieces 491 to 494 are secured on carrier element 483 to form a friction surface in the form of a circular-ring-shaped disk. Friction lining pieces 491 to 494 are spaced apart from each other in such a way that grooves are formed between friction lining pieces 491 to 494, said grooves extending as far as the carrier element 483.

In the case of the friction part 481 shown in FIG. 27, three circular or circular-segment-shaped friction lining pieces and three central pieces are in each case aligned radially. Three circular or circular-segment-shaped friction lining pieces are arranged on radial 486. Three circular or circular-segment-shaped friction lining pieces are likewise arranged on radial 488. Three central pieces are arranged on radial 487 between the respective three radially aligned circular or circular-segment-shaped friction lining pieces.

A total of three circular or circular-segment-shaped friction lining pieces 491 to 493 is combined with an inner end piece 494 and two central pieces 495, 496 in a unit 490 which is repeated in the circumferential direction.

By means of arrangement in the repeated unit 490, a rotationally symmetrical groove pattern can be formed in a simple manner. The arrangement in unit 490 furthermore offers the advantage that no residual pieces are formed during the production of the friction lining pieces, inner end pieces and central pieces. By means of the circular or circular-segment-shaped friction lining pieces, the inner end pieces and the central pieces, it is possible in a simple manner to form a large number of oil deflection points.

The grooving may extends as far as carrier element 483, which is may embodied as a carrier plate. This offers the advantage that the thermal capacity of the plate becomes usable.

The internal cross sections at the inside diameter of the friction surface allow better oil distribution over the extent of the friction surface.

In the case of the friction part 501 shown in FIG. 28, four circular or circular-segment-shaped friction lining pieces are in each case aligned radially. Four friction lining pieces are arranged on radial 506. Four friction lining pieces are likewise arranged on radial 508. Three central pieces 515 to 517 are arranged in between on radial 507. The central pieces are each substantially in the shape of crosses with circular-arc-shaped recesses.

Four circular or circular-segment-shaped friction lining pieces 511 to 514 are combined with three central pieces 515 to 517 in a unit 510 which is repeated in the circumferential direction.

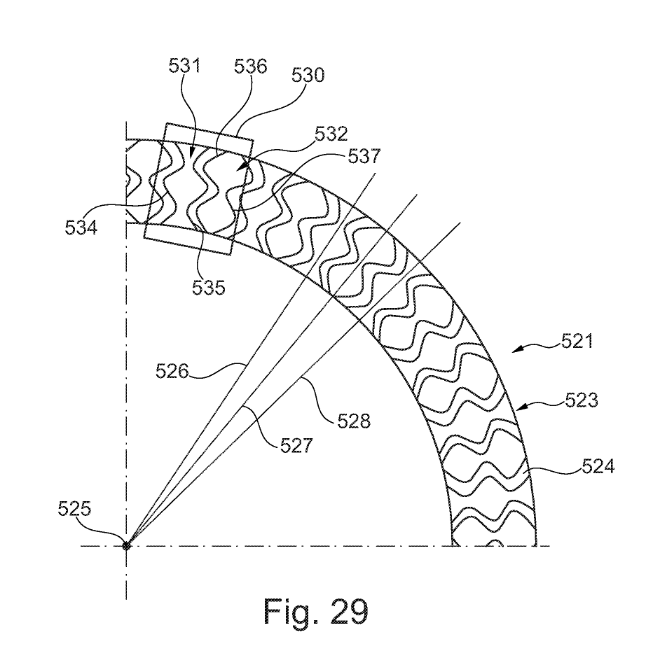

FIG. 29 relates to a friction part for a frictionally operating device, having friction lining pieces, which are spaced apart from each other by grooves in order to create a friction surface in the form of a circular-ring-shaped disk, wherein some or all of the friction lining pieces have undulating boundary lines.

An illustrative embodiment of the friction part is characterized in that the friction part has the same groove pattern over the entire extent thereof. Uniform flow through the grooves during the operation of the friction part is thereby ensured in a simple manner.

Another illustrative embodiment of the friction part is characterized in that the grooves are uniformly distributed in the circumferential direction. This simplifies the production of the friction part. Moreover, the functionality of the friction part is improved.

Another illustrative embodiment of the friction part is characterized in that the friction lining pieces each have two undulating boundary lines. It is thereby possible in a simple matter to form a large number of deflection points for the fluid in the groove pattern.

Another illustrative embodiment of the friction part is characterized in that two different shapes of friction lining piece with undulating boundary lines are combined in the friction surface. The functionality of the friction part is thereby improved.

Another illustrative embodiment of the friction part is characterized in that a first type of friction lining piece comprises undulating boundary lines with at least two wave troughs. The wave troughs and wave peaks are used to form deflection points in the groove pattern.

Another illustrative embodiment of the friction part is characterized in that a second type of friction lining piece comprises undulating boundary lines with at least two wave peaks. A wave trough is arranged between the wave peaks.

Another illustrative embodiment of the friction part is characterized in that the friction lining pieces having the undulating boundary lines are of substantially the same size. In this case, all the friction lining pieces of the first type may be of identical design. All the friction lining pieces of the second type may be likewise of identical design.

Another illustrative embodiment of the friction part is characterized in that the friction lining pieces having the undulating boundary lines are aligned radially. Accordingly, the undulating boundary lines likewise extend substantially in radial directions.

Another illustrative embodiment of the friction part is characterized in that the friction lining pieces having the undulating boundary lines are spaced apart uniformly from each other in the circumferential direction. This results in a uniform groove pattern over the extent of the friction surface.

Another illustrative embodiment of the friction part is characterized in that a number of friction lining pieces having undulating boundary lines is arranged in units which are repeated in the circumferential direction. This simplifies the production of the friction part.

Another illustrative embodiment of the friction part is characterized in that the repeated units each comprise two different friction lining pieces having undulating boundary lines. It is thereby possible in a simple matter to form a relatively large number of deflection points in the groove pattern.

A friction part 521 having a carrier element 523 is shown in a quarter section in FIG. 29. Carrier element 523 is embodied as a circular-ring-shaped disk 524 made from a steel material, for example. Radially on the inside or radially on the outside, circular-ring-shaped disk 524 is provided with inner toothing or outer toothing (not shown), for example, to form a coupling region.

Radial lines 526, 527, 528, which are also referred to as radials for short, start from a circle center 525. Friction lining pieces 531, 532 are secured on carrier element 523 to form a friction surface in the form of a circular-ring-shaped disk. Friction lining pieces 531, 532 are spaced apart from each other in such a way that grooves are formed between friction lining pieces 531, 532, said grooves extending as far as the carrier element 523.

The friction part 521 shown in FIG. 29 comprises two types of friction lining piece having undulating boundary lines. The friction lining pieces having the undulating boundary lines are aligned radially. A friction lining piece of the first type is arranged on radial 526. A further friction lining piece of the first type is arranged on radial 528.

A friction lining piece of the second type is arranged on radial 527 between radials 526 and 528. The friction lining pieces having the undulating boundary lines are spaced apart uniformly from each other in the circumferential direction. A wave trough is in each case arranged opposite a wave peak and vice versa.

A friction lining piece 531 of the first type is combined with a friction lining piece 532 of the second type in a unit 530 which is repeated in the circumferential direction. The friction lining piece 531 of the first type comprises two undulating boundary lines 534, 535 having two wave troughs. A wave peak is arranged between the wave troughs.

The friction lining piece 532 of the second type comprises two undulating boundary lines 536, 537 having two wave peaks. A wave trough is arranged between the wave peaks.

Further illustrative embodiments of the friction part are characterized in that some or all of the friction lining pieces have oblique groove walls delimiting the grooves.

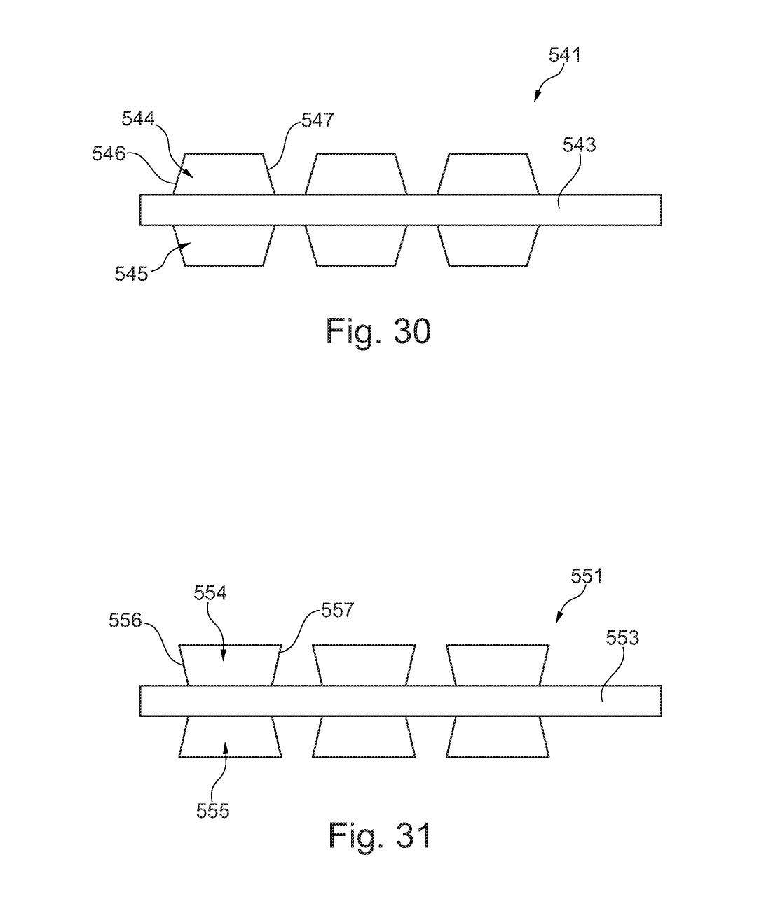

Two friction parts 541; 551 having a carrier element 543; 553 are shown in greatly simplified form in cross section in FIGS. 30 and 31. Carrier element 543; 553 is embodied as a carrier plate with a rectangular circular-ring cross section.

A total of three friction lining pieces 544; 554 is arranged on an upper side of carrier element 543; 553. A total of three friction lining pieces 545; 555 is likewise arranged on a lower side of carrier element 543; 553. Friction lining pieces 544, 545; 554, 555 are secured on carrier element 543; 553 materially for example, in particular by adhesive bonding.

Friction lining pieces 544; 545 of friction part 541 are provided with groove walls 546, 547 which extend obliquely outward. The obliquely outward oriented groove walls 546, 547 are a simple way of enabling adhesive bonding of relatively small friction lining pieces 544; 545 over a larger area.

This reduces the risk of unwanted detachment of the friction lining pieces from the carrier element. Moreover, the fluid, in particular oil, is forced more powerfully into the oil gap during the operation of friction part 541. This improves cooling.

The friction lining pieces 554, 555 of the friction part 551 shown in FIG. 31 comprise obliquely inward oriented groove walls 556, 557. The obliquely inward extending groove walls 556, 557 allow a lower pressure per unit area for a comparable groove cross section. This reduces the specific loading during the operation of friction part 551. This in turn brings about a more positive μ gradient. Moreover, an unwanted upward-float effect is reduced by a lining wedge angle of less than ninety degrees.

In general, it is the case for all rotationally symmetrical groove designs or groove arrangements that this prevents unwanted small residual pieces of friction lining pieces or pads remaining on the inside or outside diameter of the friction part or friction ring. This is advantageous since there is the risk, particularly in the case of small residual pieces, that these will be lost during operation.

### LIST OF REFERENCE SIGNS

1 friction part

3 carrier element

4 circular-ring-shaped disk

5 circle center

7 radial

8 radial

9 radial

10 radial

11 friction lining piece

12 friction lining piece

13 friction lining piece

14 friction lining piece

15 friction lining piece

16 friction lining piece

17 friction lining piece

18 friction lining piece

21 circumferential groove

22 oblique groove

23 oblique groove

26 radial

27 radial

28 radial

31 friction part

33 carrier element

34 circular-ring-shaped disk

35 circle center

36 friction lining

37 friction lining

38 friction lining

39 friction lining

40 unit

41 friction lining piece

42 friction lining piece

43 friction lining piece

44 friction lining piece

45 friction lining piece

46 friction lining piece

47 friction lining piece

48 friction lining piece

49 friction lining piece

50 friction lining piece

51 friction lining piece

52 friction lining piece

54 circumferential groove

61 friction part

63 carrier element

64 circular-ring-shaped disk

65 circle center

66 radial

67 radial

71 friction lining piece

72 friction lining piece

74 groove

81 friction part

83 carrier element

84 circular-ring-shaped disk

85 circle center

86 radial

87 radial

91 friction lining piece

92 friction lining piece

94 groove

101 friction part

103 carrier element

104 circular-ring-shaped disk

105 circle center

106 vertical

107 horizontal

108 line

109 line

111 friction lining piece

112 friction lining piece

114 groove

116 groove

117 groove

118 groove

119 groove

121 friction part

123 carrier element

124 circular-ring-shaped disk

125 circle center

126 vertical

127 horizontal

128 radial

129 line

130 line

131 friction lining piece

132 friction lining piece

134 groove

135 friction lining piece

136 friction lining piece

138 groove

140 groove

141 groove

142 groove

143 groove

144 groove

145 groove

146 groove

147 groove

161 friction part

163 carrier element

164 circular-ring-shaped disk

165 circle center

166 radial

167 radial

171 friction lining piece

172 friction lining piece

174 groove

175 imprint

181 friction part

183 carrier element

184 circular-ring-shaped disk

185 circle center

186 radial

187 radial

191 friction lining piece

192 friction lining piece

194 groove

195 imprint

196 imprint

201 friction part

203 carrier element

204 circular-ring-shaped disk

205 circle center

206 radial

207 radial

211 friction lining piece

212 friction lining piece

214 friction lining piece

215 friction lining piece

216 friction lining piece

217 friction lining piece

218 friction lining piece

219 friction lining piece

221 friction part

223 carrier element

224 circular-ring-shaped disk

225 circle center

226 radial

227 radial

228 radial

229 radial

231 friction lining piece

232 friction lining piece

233 friction lining piece

234 friction lining piece

235 friction lining piece

236 friction lining piece

237 friction lining piece

238 friction lining piece

239 friction lining piece

240 friction lining piece

241 friction part

243 carrier element

244 circular-ring-shaped disk

245 circle center

246 radial

247 radial

251 friction lining piece

252 friction lining piece

253 friction lining piece

254 friction lining piece

255 friction lining piece

256 friction lining piece

257 groove

258 groove

259 groove

261 friction part

263 carrier element

264 circular-ring-shaped disk

265 circle center

266 vertical

267 horizontal

268 line

269 line

271 friction lining piece

272 friction lining piece

273 friction lining piece

274 friction lining piece

275 friction lining piece

276 friction lining piece

281 friction part

283 carrier element

284 circular-ring-shaped disk

285 circle center

286 vertical

287 horizontal

288 line

289 line

291 friction lining piece

292 friction lining piece

293 friction lining piece

294 friction lining piece

295 friction lining piece

296 friction lining piece

297 friction lining piece

298 friction lining piece

301 friction part

303 carrier element

304 circular-ring-shaped disk

305 circle center

306 radial

307 radial

311 friction lining piece

312 friction lining piece

313 friction lining piece

314 friction lining piece

315 friction lining piece

316 friction lining piece

317 friction lining piece

319 unit

320 unit

321 friction part

323 carrier element

324 circular-ring-shaped disk

325 circle center

326 vertical

327 horizontal

328 line

329 line

330 line

331 friction lining piece

332 friction lining piece

333 friction lining piece

334 friction lining piece

335 friction lining piece

341 friction part

343 carrier element

344 circular-ring-shaped disk

345 circle center

346 radial

347 radial

351 friction lining piece

352 friction lining piece

353 friction lining piece

354 friction lining piece

355 friction lining piece

356 friction lining piece

358 unit

361 friction part

363 carrier element

364 circular-ring-shaped disk

365 circle center

366 vertical

367 horizontal

368 line

369 line

371 friction lining piece

372 friction lining piece

373 friction lining piece

374 friction lining piece

375 friction lining piece

376 friction lining piece

377 friction lining piece

378 friction lining piece

379 friction lining piece

381 friction part

383 carrier element

384 circular-ring-shaped disk

385 circle center

386 radial

387 radial

391 friction lining piece

392 friction lining piece

393 friction lining piece

394 friction lining piece

395 friction lining piece

396 friction lining piece

397 friction lining piece

398 unit

401 friction part

403 carrier element

404 circular-ring-shaped disk

405 circle center

406 vertical

407 horizontal

408 line

409 line

410 unit

411 friction lining piece

412 friction lining piece

413 friction lining piece

414 friction lining piece

415 friction lining piece

416 friction lining piece

421 friction part

423 carrier element

424 circular-ring-shaped disk

425 circle center

426 radial

427 radial

431 friction lining piece

432 friction lining piece

433 inner end piece

434 inner end piece

435 outer end piece

436 outer end piece

438 unit

439 unit

440 groove

441 friction part

443 carrier element

444 circular-ring-shaped disk

445 circle center

446 radial

447 radial

448 radial

449 radial

450 radial

451 friction lining piece

452 friction lining piece

453 inner end piece

454 inner end piece

455 inner end piece

456 outer end piece

457 outer end piece

458 outer end piece

461 friction part

463 carrier element

464 circular-ring-shaped disk

465 circle center

466 radial

467 radial

468 radial

470 unit

471 friction lining piece

472 friction lining piece

473 friction lining piece

474 friction lining piece

475 inner end piece

476 inner end piece

477 outer end piece

478 outer end piece

479 central piece

480 central piece

481 friction part

483 carrier element

484 circular-ring-shaped disk

485 circle center

486 radial

487 radial

488 radial

490 unit

491 friction lining piece

492 friction lining piece

493 friction lining piece

494 inner end piece

495 central piece

496 central piece

501 friction part

503 carrier element

504 circular-ring-shaped disk

505 circle center

506 radial

507 radial

508 radial

510 unit

511 friction lining piece

512 friction lining piece

513 friction lining piece

514 friction lining piece

515 central piece

516 central piece

517 central piece

521 friction part

523 carrier element

524 circular-ring-shaped disk

525 circle center

526 radial

527 radial

528 radial

530 unit

531 friction lining piece

532 friction lining piece

534 boundary line

535 boundary line

536 boundary line

537 boundary line

541 friction part

543 carrier element

544 friction lining piece

545 friction lining piece

546 groove wall

457 groove wall

551 friction part

553 carrier element

554 friction lining piece

555 friction lining piece

556 groove wall

557 groove wall

561 friction part

571 groove

572 groove

573 groove

575 groove

576 groove

577 groove

581 friction part

591 groove

592 groove

593 groove

595 groove

596 groove

597 groove

601 friction part

603 carrier element

604 circular-ring-shaped disk

605 circle center

701 radial

702 radial

703 radial

707 radial

710 repeated unit

711 friction lining pieces

712 friction lining piece

713 friction lining piece

714 friction lining piece

721 groove

722 groove

723 groove

724 groove

1.-10.(canceled)

11. A friction part for a frictionally operating device comprising:
a first plurality of friction lining pieces arranged to form a circular-ring-shaped disk;
wherein:
each friction lining piece in the first plurality of friction lining pieces is spaced apart from the other friction lining pieces in the first plurality of friction lining pieces to form a plurality of first grooves therebetween; and,
at least one friction lining piece in the first plurality of friction lining pieces has a shape selected from the group consisting of triangles, quadrilaterals, hexagons, crosses, cross segments, circles and circular segments.

12. The friction part for a frictionally operating device of claim 11, wherein:
at least one friction lining piece in the first plurality of friction lining pieces has a vertical groove wall; and,
the vertical groove wall delimits at least one of the first grooves.

13. The friction part for a frictionally operating device of claim 11, wherein:
at least one friction lining piece in the first plurality of friction lining pieces has an oblique groove wall; and,
the oblique groove wall delimits at least one of the first grooves.

14. The friction part for a frictionally operating device of claim 11, wherein at least one friction lining piece in the first plurality of friction lining pieces comprises a level surface.

15. The friction part for a frictionally operating device of claim 11, wherein:
at least one friction lining piece in the first plurality of friction lining pieces comprises a surface with a raised portion or a depression, and,
the raised portion or the depression forms at least one second groove in the surface.

16. A friction part for a frictionally operating device comprising:
a first plurality of friction lining pieces arranged to form a circular-ring-shaped disk, wherein:
each friction lining piece in the first plurality of friction lining pieces is spaced apart from the other friction lining pieces in the first plurality of friction lining pieces to form a plurality of first grooves therebetween;
the first plurality of friction lining pieces comprises a second plurality of friction lining pieces; and,
the second plurality of friction lining pieces comprises at least one undulating boundary line.

17. The friction part for a frictionally operating device of claim 16, wherein at least one friction lining piece in the first plurality of friction lining pieces comprises a vertical groove wall that delimits at least one of the plurality of first grooves.

18. The friction part for a frictionally operating device of claim 16, wherein at least one friction lining piece in the first plurality of friction lining pieces comprises an oblique groove wall that delimits at least one of the plurality of first grooves.

19. The friction part for a frictionally operating device of claim 16, wherein at least one friction lining piece in the first plurality of friction lining pieces comprises a level surface.

20. The friction part for a frictionally operating device of claim 16, wherein:
at least one friction lining piece in the first plurality of friction lining pieces comprises a surface with a raised portion or a depression, and,
the raised portion or the depression forms at least one second groove in the surface.
